(19) United States
(12) Patent Application Publication
(10) Pub. No.: US 2026/0067388 A1
(43) Pub. Date: Mar. 5, 2026

(54) ELECTRONIC DEVICE

(71) Applicant: Samsung Electronics Co., Ltd., Suwon-si (KR)

(72) Inventors: Jinsook AHN, Suwon-si (KR); Sungwon PARK, Suwon-si (KR); Yuji YU, Suwon-si (KR); Youngsun LEE, Suwon-si (KR); Cheolyoon CHUNG, Suwon-si (KR)

(21) Appl. No.: 19/317,655

(22) Filed: Sep. 3, 2025

Related U.S. Application Data
(63) Continuation of application No. PCT/KR2025/013492, filed on Sep. 2, 2025.

(30) Foreign Application Priority Data
Sep. 5, 2024 (KR) 10-2024-0120732
Dec. 3, 2024 (KR) 10-2024-0177011

(51) Int. Cl. H04M 1/02; H01Q 1/24

(52) U.S. Cl. CPC H04M 1/0268; H01Q 1/243; H04M 1/0203; H04M 1/0216

(57) ABSTRACT

An electronic device is provided. The electronic device includes a flexible display including a display panel, a polymer member disposed on a rear surface of the display panel, and a support plate disposed on a rear surface of the polymer member, wherein the support plate includes a first flat portion, a second flat portion, a bendable portion, and at least one differential signal line including a first signal line and a second signal line, the at least one differential signal line extending from at least a portion of the first flat portion to at least a portion of the second flat portion the bendable portion, wherein, in the bendable portion, the first signal line extends along a first curved path including a plurality of U-shaped sections disposed around a plurality of openings, and wherein, in the bendable portion, the second signal line extends along a second curved path including a plurality of U-shaped sections disposed around the plurality of openings.

### CROSS-REFERENCE TO RELATED APPLICATION(S)

This application is a continuation application, claiming priority under 35 U.S.C. § 365 (c), of an International application No. PCT/KR2025/013492, filed on Sep. 2, 2025, which is based on and claims the benefit of a Korean patent application number 10-2024-0120732, filed on Sep. 5, 2024, in the Korean Intellectual Property Office, and of a Korean patent application number 10-2024-0177011, filed on Dec. 3, 2024, in the Korean Intellectual Property Office, the disclosure of each of which is incorporated by reference herein in its entirety.

### TECHNICAL FIELD

The disclosure relates to a foldable electronic device.

### BACKGROUND ART

As functional differences between electronic devices from respective manufacturers have become significantly reduced, the electronic devices are gradually becoming slimmer to satisfy consumers' purchasing needs, and development is being conducted to increase the rigidity of the electronic devices, enhance design aspects of the electronic devices, and differentiate the functional elements of the electronic devices. Such electronic devices are gradually evolving from uniform rectangular shapes into various forms. For example, an electronic device may have a transformable structure that is easy to carry and allows use of a large display screen when in use.

The above information is presented as background information only to assist with an understanding of the disclosure. No determination has been made, and no assertion is made, as to whether any of the above might be applicable as prior art with regard to the disclosure.

### DISCLOSURE OF INVENTION

Foldable-type electronic devices are continuously being released as part of electronic devices, and a support plate for a foldable display may include a bendable portion. The bendable portion of the support plate may be configured to allow folding by a plurality of openings being arranged at intervals.

A foldable-type electronic device may include at least one signal line, which is a line configured to transmit a signal, on the support plate, and the signal line of the support plate may be disposed to extend across the bendable portion. For example, the signal line may be disposed to bypass a plurality of openings arranged in the bendable portion.

However, due to the narrow intervals between the plurality of openings, the design of the line width of the signal line may be limited when the signal line extends across the bendable portion. When the line width design is limited, the width of the signal line may inevitably become narrow, which may cause degradation in the performance of the signal line. For example, due to the narrow line width in the bendable portion, the signal line may cause signal loss when transmitting a high-speed signal.

Aspects of the disclosure are to address at least the above-mentioned problems and/or disadvantages and to provide at least the advantages described below. Accordingly, an aspect of the disclosure is to provide a support plate including a signal line structure capable of reducing signal loss, and an electronic device including the same.

Additional aspects will be set forth in part in the description which follows and, in part, will be apparent from the description, or may be learned by practice of the presented embodiments.

In accordance with an aspect of the disclosure, an electronic device is provided. The electronic device includes a foldable housing including a first housing, a second housing, and a hinge structure connecting the first housing and the second housing, and a flexible display disposed on the foldable housing, wherein the flexible display includes a display panel, a polymer member disposed on a rear surface of the display panel, and a support plate disposed on a rear surface of the polymer member, wherein the support plate includes a first flat portion facing the first housing, a second flat portion facing the second housing, a bendable portion disposed between the first flat portion and the second flat portion to face the hinge structure and including a plurality of openings arranged at intervals, the bendable portion being configured to be bendable via the plurality of openings, and at least one differential signal line including a first signal line and a second signal line, the at least one differential signal line extending from at least a portion of the first flat portion to at least a portion of the second flat portion across the bendable portion, wherein the first signal line and the second signal line are disposed on the first flat portion and the second flat portion, wherein in the bendable portion, the first signal line extends along a first curved path including a plurality of U-shaped sections disposed around the plurality of openings, and wherein, in the bendable portion, the second signal line extends along a second curved path including a plurality of U-shaped sections disposed around the plurality of openings.

In accordance with another aspect of the disclosure, an electronic device is provided. The electronic device includes a foldable housing including a first housing, a second housing, and a hinge structure connecting the first housing and the second housing, and a flexible display disposed on the foldable housing, wherein the flexible display includes a display panel, a polymer member disposed on a rear surface of the display panel, and a support plate disposed on a rear surface of the polymer member, wherein the support plate includes a first flat portion facing the first housing, a second flat portion facing the second housing, a bendable portion disposed between the first flat portion and the second flat portion to face the hinge structure and including a plurality of openings arranged at intervals, the bendable portion being configured to be bendable via the plurality of openings, and at least one differential signal line including a first signal line and a second signal line, the at least one differential signal line extending from at least a portion of the first flat portion to at least a portion of the second flat portion across the bendable portion, wherein, in the first flat portion and the second flat portion, the first signal line and the second signal line are disposed side by side at a predetermined interval, wherein, in the bendable portion, the first signal line extends along a first curved path bypassing the plurality of openings, and wherein, in the bendable portion, the second signal line extends along a second curved path overlapping at least a portion of the first curved path, and the second signal line being disposed on a different layer from the first signal line in the second curved path.

According to embodiments of the disclosure, signal loss is reduced when designing a signal line that extends across a bendable portion in a foldable electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a perspective view illustrating an electronic device in a flat or unfolded state according to an embodiment of the disclosure;

FIG. 2B is a plan view illustrating the front side of the electronic device in the unfolded state according to an embodiment of the disclosure;

FIG. 2C is a plan view illustrating the rear side of the electronic device in the unfolded state according to an embodiment of the disclosure;

FIG. 3A is a perspective view of an electronic device illustrating a folded state according to an embodiment of the disclosure;

FIG. 3B is a perspective view of an electronic device illustrating an intermediate state according to an embodiment of the disclosure;

FIG. 4 is an exploded perspective view of the electronic device according to an embodiment of the disclosure;

FIG. 5 is an exploded perspective view illustrating a stacked structure of a flexible display according to an embodiment of the disclosure;

FIG. 6 is an enlarged plan view of a portion of the support plate illustrated in FIG. 5 according to an embodiment of the disclosure;

FIG. 7 is a plan view schematically illustrating a support plate according to an embodiment of the disclosure;

FIG. 8A is a front perspective view of a multi-foldable electronic device in a fully unfolded state according to an embodiment of the disclosure;

FIG. 8B is a plan view of the multi-foldable electronic device in the fully unfolded state according to an embodiment of the disclosure;

FIG. 8C is a rear perspective view of the multi-foldable electronic device in the fully unfolded state according to an embodiment of the disclosure;

FIG. 9A is a front perspective view of a multi-foldable electronic device in a fully folded state according to an embodiment of the disclosure;

FIGS. 9B and 9C are perspective views illustrating the multi-foldable electronic device, in which the rear surface of the multi-foldable electronic device is shown in various directions in the fully folded state according to various embodiments of the disclosure;

FIGS. 10, 11, 12, and 13 are plan views each schematically illustrating a support plate of a multi-foldable electronic device in an unfolded state according to various embodiments of the disclosure;

FIG. 14 is a plan view illustrating some of signal lines of a support plate according to a comparative example according to an embodiment of the disclosure;

FIG. 15 is a plan view illustrating a portion of a differential signal line of a support plate according to an embodiment of the disclosure;

FIG. 16 is a plan view illustrating a portion of a ground line of a support plate according to an embodiment of the disclosure;

FIG. 17 is a plan view illustrating a portion of a differential signal line of a support plate according to an embodiment of the disclosure;

FIGS. 18A, 18B, 19A, 19B, 20A, 20B, 21A, 21B, and 21C are cross-sectional views illustrating various embodiments for the laminated structure of the support plate illustrated in FIG. 17 according to various embodiments of the disclosure; and

FIG. 22 is a plan view illustrating a portion of a radio frequency (RF) signal line of a support plate according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

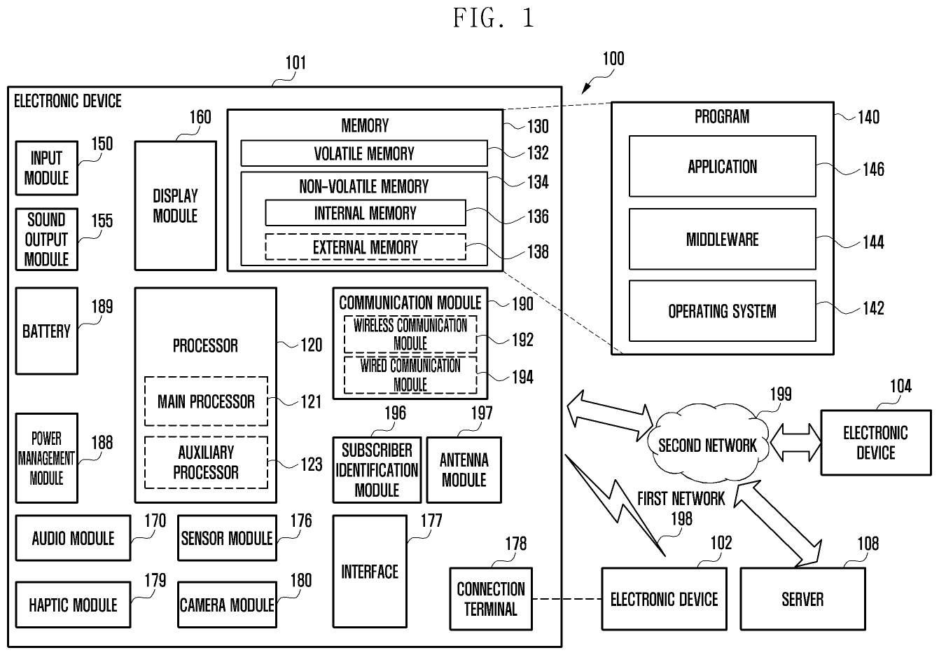

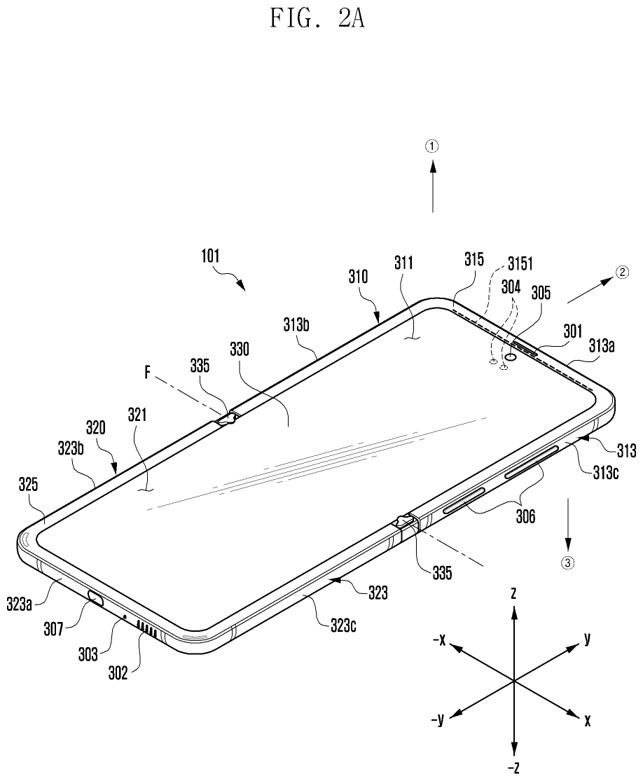

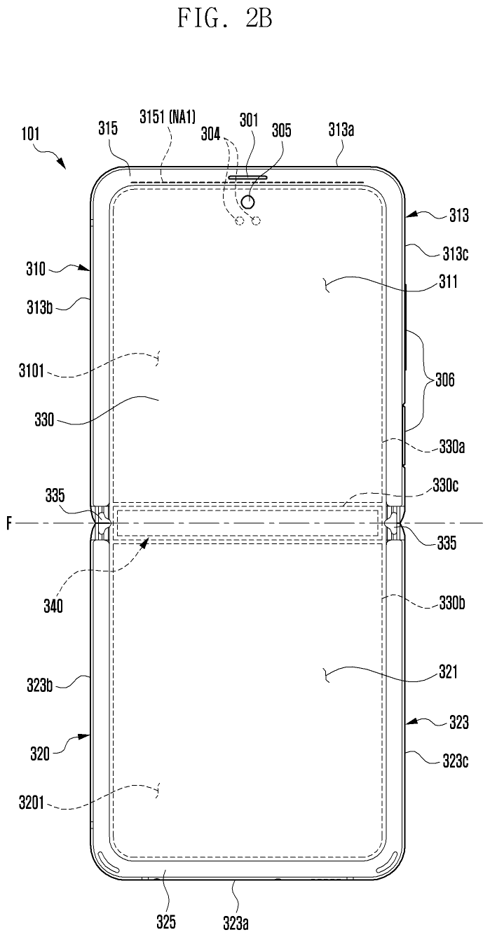

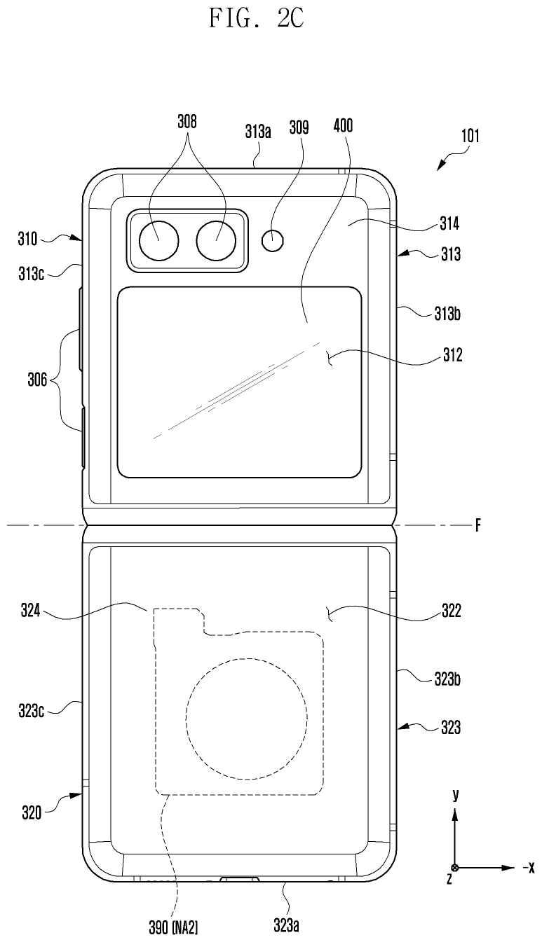

Each of the embodiments described with reference to the drawings of the disclosure may be independently configured as a single embodiment. For example, the embodiment of FIG. 1 and the embodiment of FIGS. 2A to 2C may be independently configured from each other. Each of the embodiments described with reference to the drawings of the disclosure may operate independently as a single embodiment. For example, the embodiment of FIG. 1 and the embodiment of FIGS. 2A to 2C may operate independently from each other.

At least two of the embodiments described with reference to the drawings of the disclosure may be combined and configured. For example, at least a portion of the embodiment of FIG. 1 and at least a portion of the embodiment of FIGS. 2A to 2C may be combined and configured with each other. At least two of the embodiments described with reference to the drawings of the disclosure may be combined to operate together. For example, at least a portion of the embodiment of FIG. 1 and at least a portion of the embodiment of FIGS. 2A to 2C may be combined to operate together.

When at least two of the embodiments described with reference to the drawings of the disclosure are combined, at least some components and/or at least some operations included in each embodiment may be omitted. For example, when the embodiment of FIG. 1 and the embodiment of FIGS. 2A to 2C are combined, at least some components and/or at least some operations included in the embodiment of FIG. 1 may be omitted, and at least some components and/or at least some operations included in the embodiment of FIGS. 2A to 2C may be omitted.

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

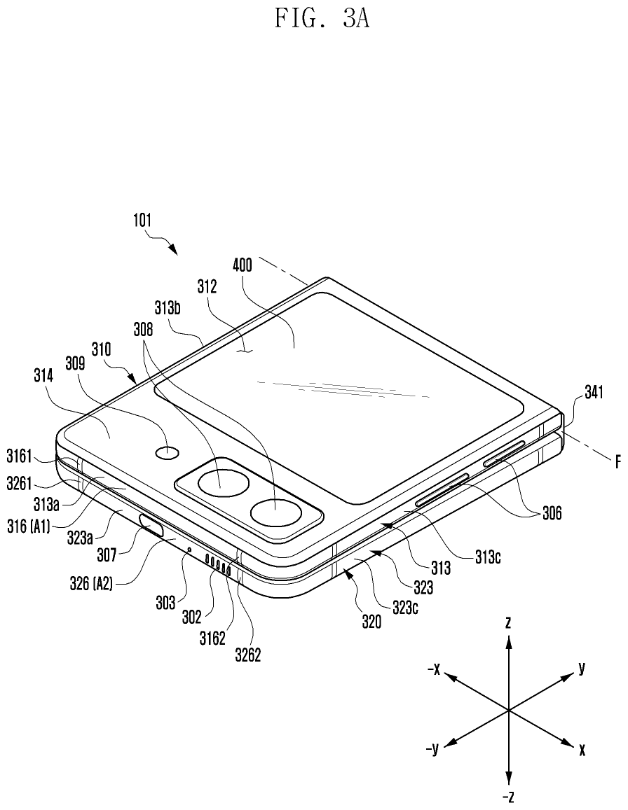

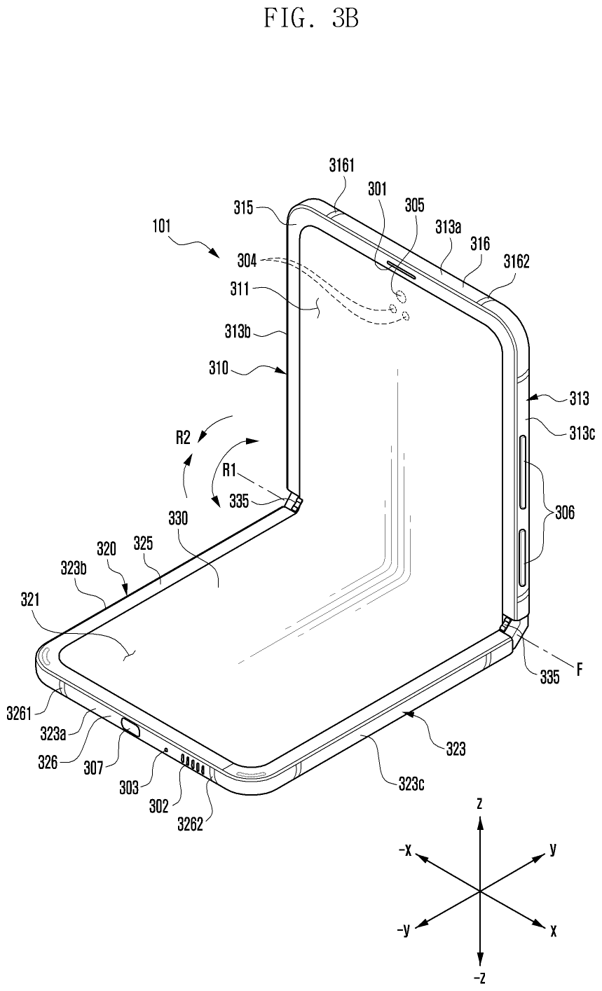

FIG. 2A is a perspective view illustrating an electronic device in a flat or unfolded state according to an embodiment of the disclosure. FIG. 2B is a plan view illustrating the front side of the electronic device in the unfolded state according to an embodiment of the disclosure. FIG. 2C is a plan view illustrating the rear side of the electronic device in the unfolded state according to an embodiment of the disclosure. FIG. 3A is a perspective view of an electronic device illustrating a folded state according to an embodiment of the disclosure. FIG. 3B is a perspective view of an electronic device illustrating an intermediate state according to an embodiment of the disclosure.

The electronic device 101 of FIGS. 2A to 2C, 3A, and 3B may be at least partially similar to the electronic device 101 of FIG. 1 or may further include other embodiments for the electronic device.

Referring to FIGS. 2A to 2C, 3A, and 3B, the electronic device 101 may include a pair of housings 310 and 320 (e.g., a foldable housing) that are rotatably coupled to each other to be folded to face each other about a hinge structure (e.g., the hinge structure 340 of FIG. 2B) (e.g., a hinge device or a hinge module). The hinge structure 340 may be arranged in the x-axis direction or the y-axis direction. In some embodiments, two or more hinge structures 340 may be disposed to be folded in the same direction or in different directions. The electronic device 101 may include a first display 330 (e.g., a flexible display) disposed in an area defined by the pair of housings 310 and 320. The first housing 310 and the second housing 320 may be disposed on both sides of a folding axis F and may have a shape that is substantially symmetrical with respect to the folding axis F. The first housing 310 and the second housing 320 may have a different angle or distance from each other depending on whether the state of the electronic device 101 is a flat state (or unfolded state), a folded state, or an intermediate state.

The pair of housings 310 and 320 may include the first housing 310 (e.g., a first housing structure) coupled to the hinge structure 340 and the second housing 320 (e.g., a second housing structure) coupled to the hinge structure 340. In the flat state, the first housing 310 may include a first surface 311 (e.g., the front surface) oriented forward (e.g., in the z-axis direction), and a second surface 312 (e.g., the rear surface) oriented rearward to face away from the first surface 311 (e.g., in the −z-axis direction). In the flat state, the second housing 320 may include a third surface 321 (e.g., the front surface) oriented forward (e.g., in the z-axis direction), and a fourth surface 322 (e.g., the rear surface) oriented rearward (e.g., in the −z-axis direction). In the flat state, the electronic device 101 may be operated such that the first surface 311 of the first housing 310 and the third surface 321 of the second housing 320 are oriented in substantially the same first direction (e.g., the z-axis direction), and in the folded state, the first surface 311 and the third surface 321 face each other. In the flat state, the electronic device 101 may be operated such that the second surface 312 of the first housing 310 and the fourth surface 322 of the second housing 320 are oriented in substantially the same second direction (e.g., the −z-axis direction), and in the folded state, the second surface 312 and the fourth surface 322 face away from each other. For example, in the folded state, the second surface 312 may be oriented in the first direction (e.g., the z-axis direction), and the fourth surface 322 may be oriented in the second direction (e.g., the −z-axis direction).

The first housing 310 may include a first side surface member 313 defining at least a portion of the exterior of the electronic device 101, and a first rear surface cover 314 coupled to the first side surface member 313 and defining at least a portion of the second surface 312 of the electronic device 101. The first side surface member 313 may include a first side surface 313a, a second side surface 313b extending from one end of the first side surface 313a, and a third side surface 313c extending from the other end of the first side surface 313a. The first side surface member 313 may have a rectangular (e.g., square or oblong) shape defined by the first side surface 313a, the second side surface 313b, and the third side surface 313c.

The second housing 320 may include a second side surface member 323 defining at least a portion of the external appearance of the electronic device 101, and a second rear surface cover 324 coupled to the second side surface member 323 and defining at least a portion of the fourth surface 322 of the electronic device 101. The second side surface member 323 may include a fourth side surface 323a, a fifth side surface 323b extending from one end of the fourth side surface 323a, and a sixth side surface 323c extending from the other end of the fourth side surface 323a. The second side surface member 323 may have a rectangular shape defined by the fourth side surface 323a, the fifth side surface 323b, and the sixth side surface 323c. The first housing 310 and the second housing 320 may be configured as a foldable housing (e.g., a foldable housing structure or a housing structure).

The pair of housings 310 and 320 is not limited to the shape and coupling illustrated in the figures, but may be implemented by other shapes or combinations and/or couplings of components. For example, in some embodiments, the first side surface member 313 may be integrated with the first rear surface cover 314, and the second side surface member 323 may be integrated with the second rear surface cover 324.

In the unfolded state of the electronic device 101, the second side surface 313b of the first side surface member 313 and the fifth side surface 323b of the second side surface member 323 may be connected to each other. In the unfolded state of the electronic device 101, the third side surface 313c of the first side surface member 313 and the sixth side surface 323c of the second side surface member 323 may be connected to each other. The electronic device 101 may be configured such that, in the unfolded state, the total length of the second side surface 313b and the fifth side surface 323b is greater than the length of the first side surface 313a and/or the fourth side surface 323a. In addition, the total length of the third side surface 313c and the sixth side surface 323c may be longer than the length of the first side surface 313a and/or the fourth side surface 323a.

According to an embodiment of the disclosure, the first side surface member 313 and/or the second side surface member 323 may be made of a metal (e.g., a conductive member or conductive area), or may further include a polymer (e.g., a non-conductive member or non-conductive area) injection-molded onto the metal. The first side surface member 313 and/or the second side surface member 323 may include at least one conductive portion 316 and/or 326 that is electrically segmented by at least one segmentation portion 3161, 3162, and/or 3261, 3262 made of a polymer (e.g., a non-conductive portion or gap). In such a case, the at least one conductive portion 316 and/or 326 may be electrically connected to a wireless communication circuit (e.g., a cellular communication circuit, such as the wireless communication module 192 of FIG. 1) included in the electronic device 101, and may be used as an antenna operating in at least one predetermined band (e.g., about 400 MHz to about 6,000 MHz).

According to an embodiment of the disclosure, the first rear surface cover 314 and/or the second rear surface cover 324 may be made of at least one of, for example, coated or colored glass, ceramic, polymer, or metal (e.g., aluminum, stainless steel (STS), or magnesium) or a combination of at least two of these materials.

The first display 330 may be disposed to extend from the first surface 311 of the first housing 310 to at least a portion of the third surface 321 of the second housing 320 across the hinge structure 340 (e.g., a hinge module or hinge assembly). For example, the first display 330 may include a first portion 330a substantially corresponding to the first surface 311, a second portion 330b substantially corresponding to the third surface 321, and a third portion 330c (e.g., a bendable area) that connects the first portion 330a and the second portion 330b and corresponds to the hinge structure 340.

The electronic device 101 may include a first protection member 315 (e.g., a first cover, first protection frame, first protection cover, or first decorative member) coupled along an edge of the first housing 310. The electronic device 101 may include a second protection member 325 (e.g., a second cover, second protection frame, second protection cover, or second decorative member) coupled along an edge of the second housing 320. According to an embodiment of the disclosure, the first protection member 315 and/or the second protection member 325 may be made of a metal or a polymer material. In an embodiment, the first protection member 315 and/or the second protection member 325 may be used as a decoration member. The first display 330 may be positioned such that an edge of the first portion 330a is interposed between the first housing 310 and the first protection member 315. The first display 330 may be positioned such that an edge of the second portion 330b is interposed between the second housing 320 and the second protection member 325. The first display 330 may be positioned such that an edge of the first display 330 is protected by a protection cap 335 disposed in an area corresponding to the hinge structure 340. Accordingly, the edge of the first display 330 may be substantially protected from the outside. The electronic device 101 may include a hinge housing 341 (e.g., a hinge cover) that supports the hinge structure 340. When the electronic device 101 is in the folded state, the hinge housing is exposed to the exterior, and when the electronic device is in the unfolded state, the hinge housing is retracted into a first space 3101 of the first housing 310 and a second space 3201 of the second housing 320 so as to be hidden from the exterior. The first display 330 may be disposed to extend from at least a portion of the second surface 312 to at least a portion of the fourth surface 322. In this case, the electronic device 101 may be folded to expose the first display 330 outside (out-folding type).

The electronic device 101 may include a second display 400 (e.g., a sub-display) disposed separately from the first display 330. The second display 400 may be disposed on the second surface 312 of the first housing 310 to be at least partially exposed, so that, in the folded state, the second display 400 may replace the display function of the first display 330 and display status information of the electronic device 101. The second display 400 may be arranged to be visible from the outside through at least a partial area in the first rear surface cover 314. In some embodiments, the second display 400 may be disposed on the fourth surface 322 of the second housing 320. In this case, the second display 400 may be disposed to be visible from the outside through at least a partial area of the second rear surface cover 324.

The electronic device 101 may include at least one of an input device 303 (e.g., a microphone), sound output devices 301 and 302, a sensor module 304, camera devices 305 and 308, key input devices 306, or a connector port 307. In the illustrated embodiment, the input device 303 (e.g., a microphone), the sound output devices 301 and 302, the sensor module 304, the camera devices 305 and 308, the key input devices 306, or the connector port 307 are referred to as holes or shapes provided in the first housing 310 or the second housing 320, but may include practical electronic components (e.g., an input device, a sound output device, a sensor module, or a camera device) disposed inside the electronic device 101 and operating through the holes or shapes.

The input device 303 may include at least one microphone 303 disposed in the second housing 320. In some embodiments, the input device 303 may include multiple microphones 303 arranged to detect the direction of sound. The plurality of microphones 303 may be disposed at appropriate positions in the first housing 310 and/or the second housing 320. The sound output devices 301 and 302 may include speakers 301 and 302. The speakers 301 and 302 may include a phone call receiver 301 disposed in the first housing 310 and a speaker 302 disposed in the second housing 320. The input device 303, the sound output devices 301 and 302, and the connector port 307 may be disposed in a space provided in the first housing 310 and/or a space provided in the second housing 320 of the electronic device 101, and may be exposed to the external environment through one or more holes provided in the first housing 310 and/or the second housing 320. At least one connector port 307 may be used to transmit/receive power and/or data to/from an external electronic device. At least one connector port (e.g., an ear jack hole) may accommodate a connector (e.g., an ear jack) for transmitting/receiving an audio signal to/from an external electronic device. The holes provided in the first housing 310 and/or the second housing 320 may be commonly used for the input device 303 and the sound output devices 301 and 302. The sound output devices 301 and 302 may include a speaker that operates without holes provided in the first housing 310 and/or the second housing 320 (e.g., a piezo speaker).

The sensor modules 304 may generate electrical signals or data values corresponding to an internal operating state or an external environmental state of the electronic device 101. The sensor modules 304 may detect an external environment through, for example, the first surface 311 of the first housing 310. The electronic device 101 may further include at least one sensor module disposed to detect an external environment through the second surface 312 of the first housing 310. The sensor modules 304 (e.g., an illuminance sensor) may be disposed under the first display 330 to detect an external environment through the first display 330. The sensor module 304 may include at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, an illuminance sensor, a proximity sensor, a biometric sensor, an ultrasonic sensor, or an illuminance sensor.

The camera devices 305 and 308 may include a first camera device 305 disposed on the first surface 311 of the first housing 310 (e.g., a front camera device) and a second camera device 308 disposed on the second surface 312 of the first housing 310. The electronic device 101 may further include a flash 309 disposed near the second camera device 308. In an embodiment, the camera devices 305 and 308 may include one or more lenses, an image sensor, and/or an image signal processor. The flash 309 may include, for example, a light-emitting diode or a xenon lamp. The camera devices 305 and 308 may be arranged such that two or more lenses (e.g., a wide-angle lens, an ultra-wide-angle lens, or a telephoto lens) and image sensors may be arranged to be located on one surface (e.g., the first surface 311, the second surface 312, the third surface 321, or the fourth surface 322) of the electronic device 101. In some embodiments, the camera devices 305 and 308 may each include time-of-flight (TOF) lenses and/or an image sensor.

The key input devices 306 (e.g., key buttons) may be arranged on the third side surface 313c of the first side surface member 313 of the first housing 310. In other embodiments, the key input devices 306 may be disposed on at least one of the other side surfaces 313a and 313b of the first housing 310 and/or the side surfaces 323a, 323b, and 323c of the second housing 320. Some or all of the key input devices 306 may be omitted, and the key input devices 306 not included in the electronic device 100 may be implemented in another form such as soft keys on the first display 330. In some embodiments, the key input devices 306 may be implemented by using pressure sensors included in the first display 330.

At least one of the camera devices 305 and 308 (e.g., the first camera device 305) or the sensor modules 304 may be arranged to be exposed through the first display 330. For example, the first camera device 305 or the sensor modules 304 may be disposed in the inner space of the electronic device 101 to be in contact with the external environment through an opening (e.g., a through hole) at least partially provided in the first display 330. In another embodiment, some sensor modules 304 may be disposed to execute their functions in the inner space of the electronic device 101 without being visually exposed through the first display 330. For example, in this case, the opening in the area facing the sensor modules 304 of the first display 330 may be omitted.

Referring to FIG. 3B, the electronic device 101 may be operated to maintain the intermediate state via the hinge structure 340. In this case, the electronic device 101 may control the first display 330 such that the display area corresponding to the first surface 311 and the display area corresponding to the third surface 321 display different contents, respectively. With reference to a predetermined inflection angle (e.g., the angle between the first housing 310 and the second housing 320 in the intermediate state), the electronic device may operate in a substantially unfolded state (e.g., the unfolded state in FIG. 2A) and/or in a substantially folded state (e.g., the folded state in FIG. 3A) via the hinge structure 340. For example, in the intermediate state of being unfolded to a predetermined inflection angle via the hinge structure 340, when a pressing force is applied in the unfolding direction (direction R1), the electronic device 101 may be operated to transition to the unfolded state (e.g., the unfolded state in FIG. 2A). For example, in the intermediate state of being unfolded to a predetermined inflection angle via the hinge structure 340, when a pressing force is applied in the folding direction (direction R2), the electronic device 101 may be operated to transition to the closed state (e.g., the folded state in FIG. 3A). The electronic device 101 may be operated to maintain the unfolded state (not illustrated) at various angles via the hinge structure 340.

According to an embodiment, the electronic device 101 may include a conductive layer 3151 (e.g., a first conductive pattern or a first conductor) disposed between the first housing 310 and the first protection member 315. The conductive layer 3151 may be disposed on an inner surface of the first protection member 315 so as to be visible from the exterior. The conductive layer 3151 may be electrically connected to a near-field wireless communication circuit (e.g., the wireless communication module 192 of FIG. 1) disposed in the inner space of the electronic device 101. The near-field wireless communication circuit may be configured to transmit and/or receive wireless signals in a frequency band of about 13.56 MHz via the conductive layer 3151. The conductive layer 3151 may function as a near-field communication antenna NA1 (e.g., a first near-field communication antenna). The near-field communication antenna NA1 may be disposed along the longitudinal direction (e.g., +x-axis direction) of a first side surface 313a near the first side surface 313a of the electronic device 101, and may form a wireless signal in a direction in which the front surface 311 of the electronic device 101 is oriented (e.g., the z-axis direction), a direction in which the side surface 313a is oriented (e.g., the y-axis direction), or a direction between the front surface 311 and the side surface 313a (e.g., a direction between the z-axis and the y-axis).

The electronic device 101 may include a conductive coil 390 (e.g., an antenna member) (e.g., a second conductive pattern or second conductor) configured to form a wireless signal in a rearward direction (e.g., the −z-axis direction) of the electronic device 101 in the unfolded state. The conductive coil 390 may be electrically connected to a near-field wireless communication circuit disposed in an inner space (e.g., the second space 3201 of the second housing 320) of the electronic device 101. The near-field wireless communication circuit may be configured to transmit and/or receive a wireless signal in a frequency band of about 13.56 MHz through the conductive coil 390. In an embodiment, the conductive coil 390 may also function as another near-field communication antenna NA2 (e.g., a second near-field communication antenna).

The electronic device 101 according to an embodiment of the disclosure may be configured to form a near-field communication wireless signal not only toward the rear surface of the electronic device 101 but also toward the front surface and/or the side surface, thereby contributing to improved usability of the electronic device 101.

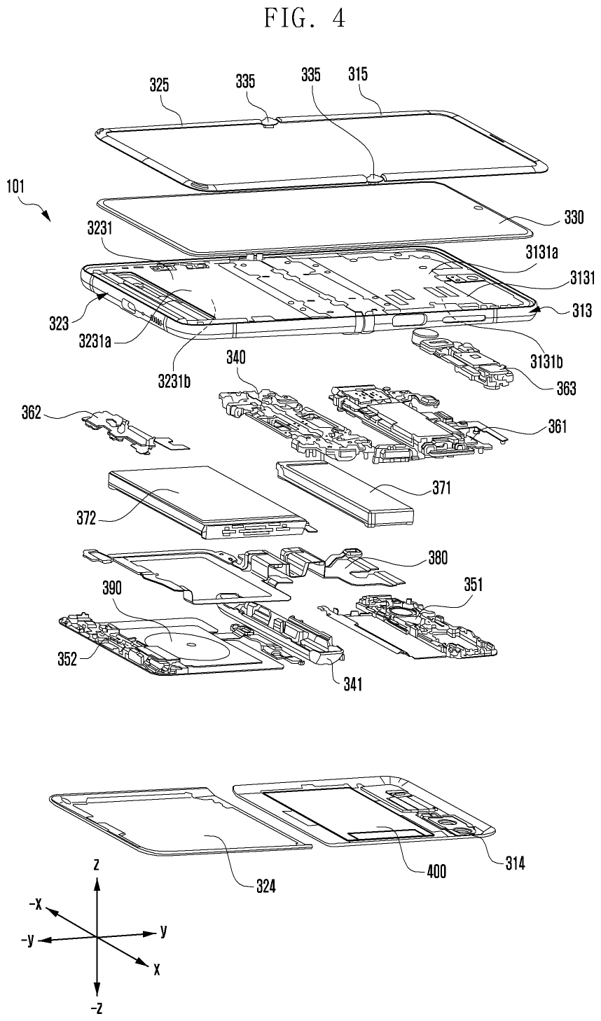

FIG. 4 is an exploded perspective view of the electronic device according to an embodiment of the disclosure.

Referring to FIG. 4, the electronic device 101 may include a first side surface member 313 (e.g., a first side surface frame), a second side surface member 323 (e.g., a second side surface frame), and a hinge structure 340 (e.g., a hinge module or hinge assembly) rotatably connecting the first side surface member 313 and the second side surface member 323. The electronic device 101 may include a first extension member 3131 extending at least partially from the first side surface member 313, or a second extension member 3231 extending at least partially from the second side surface member 323. The first extension member 3131 may include a first surface 3131a facing the front surface of the electronic device 101 (e.g., in the z-axis direction), and the second surface 3131b facing away from the first surface 3131a (e.g., in the −z-axis direction). The second extension member 3231 may include a third surface 3231a facing the front surface of the electronic device 101 (e.g., in the z-axis direction), and the fourth surface 3231b facing away from the third surface 3231a (e.g., in the −z-axis direction). The first extension member 3131 may be integrated with the first side surface member 313 or structurally coupled to the first side surface member 313. The second extension member 3231 may be integrated with the second side surface member 323 or structurally coupled to the second side surface member 323. The electronic device 101 may include a first display 330 disposed to be supported by the first surface 3131a of the first extension member 3131 and the third surface 3231a of the second extension member 3231. The electronic device 101 may include a first rear surface cover 314 coupled to the first side surface member 313 and configured to provide a first space (e.g., the first space 3101 of FIG. 2B) between the first rear surface cover and the second surface 3131b of the first extension member 3131, and a second rear surface cover 324 coupled to the second side surface member 323 and configured to provide a second space (e.g., the second space 3201 of FIG. 2B) between the second rear surface cover and the fourth surface 3231b of the second extension member 3231. The first side surface member 313 and the first rear surface cover 314 may be integrally configured. The second side surface member 323 and the second rear surface cover 324 may be integrated. The electronic device 101 may include a first housing (e.g., the first housing 310 of FIG. 2A) (e.g., a first housing structure) provided by the first side surface member 313, the first extension member 3131, and the first rear surface cover 314. The electronic device 101 may include a second housing (e.g., the second housing 320 of FIG. 2A) (e.g., a second housing structure) provided by the second side surface member 323, the second extension member 3231, and the second rear surface cover 324. The electronic device 101 may include a second display 400 disposed between the first rear surface cover 314 and the second surface 3131b of the first extension member 3131, such that at least a portion of the second display 400 is visible from the exterior through at least a portion of the first rear surface cover 314.

The electronic device 101 may include a first substrate 361 (e.g., a first printed circuit board (PCB) or a main PCB), a camera assembly 363, a first battery 371, or a first bracket 351, which may be disposed in the first space between the first side surface member 313 and the first rear surface cover 314. The camera assembly 363 may include a plurality of camera devices (e.g., the camera devices 305 and 308 of FIGS. 2A and 3A) and may be electrically connected to the first substrate 361. The first bracket 351 may provide a support structure for supporting the first substrate 361 and/or the camera assembly 363 and improved rigidity.

The electronic device 101 may include a second substrate 362 (e.g., a second printed circuit board (PCB) or a sub-PCB), a conductive coil 390 (e.g., an antenna member), a second battery 372, or a second bracket 352, which may be disposed in the second space between the second side surface member 323 and the second rear surface cover 324. In an embodiment, the electronic device 101 may include a wiring member 380 (e.g., a flexible printed circuit board (FPCB)) configured to extend from the first substrate 361, across the hinge structure 340, to a plurality of electronic components (e.g., the second substrate 362, the second battery 372, or the conductive coil 390) disposed between the second side surface member 323 and the second rear surface cover 324, and to provide electrical connection. The conductive coil 390 may function as at least one of a near-field communication (NFC) antenna, a wireless charging antenna, and/or a magnetic secure transmission (MST) antenna. For example, the conductive coil 390 may perform near-field communication with an external device or transmit/receive power required for charging wirelessly.

The electronic device 101 may include a hinge housing 341 (e.g., a hinge cover) configured to support the hinge structure 340 and to be exposed to the exterior when the electronic device 101 is in the folded state (e.g., the folded state of FIG. 3A), and to be retracted into the first space and/or the second space when the electronic device is in the unfolded state (e.g., the unfolded state of FIG. 2A) so as to be hidden from the exterior.

The electronic device 101 may include a first protection member 315 coupled along an edge of the first side surface member 313. The electronic device 101 may include a second protection member 325 coupled along an edge of the second side surface member 323. An edge of a first flat portion (e.g., the first portion 330a of FIG. 3B) of the first display 330 may be protected by the first protection member 315. An edge of a second flat portion (e.g., the second portion 330b of FIG. 3B) of the first display 330 may be protected by the second protection member 325. The electronic device 101 may include protection caps 335 disposed to protect an edge of a flexible portion (e.g., the third portion 330c of FIG. 3B) of the first display 330 corresponding to the hinge structure 340. In some embodiments, the protection caps 335 and/or the protection members 315 and 325 may be omitted.

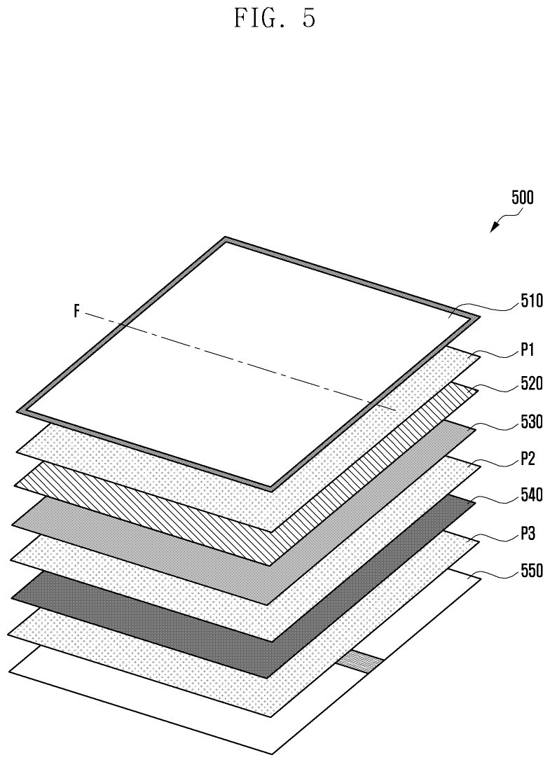

FIG. 5 is an exploded perspective view illustrating a stacked structure of a flexible display according to an embodiment of the disclosure.

The flexible display 500 of FIG. 5 may be at least partially similar to the first display 330 of FIG. 2A or may further include other embodiments for the display.

Referring to FIG. 5, the flexible display 500 (e.g., the first display 330 of FIG. 2A) may include a window 510 (e.g., a polyimide (PI) film), and a polarizer (POL) 520 (e.g., a polarizing film), a display panel 530, a polymer member 540, and/or a support plate 550 sequentially disposed on the rear surface of the window 510. The flexible display 500 may be disposed to extend from at least a portion of an inner space of a first housing (e.g., the first housing 310 of FIG. 2A) to at least a portion of an inner space of a second housing (e.g., the second housing 320 of FIG. 2A). For example, the flexible display 500 may extend from at least a portion of an inner space of a first housing (e.g., the first housing 310 of FIG. 2A) to at least a portion of an inner space of a second housing (e.g., the second housing 320 of FIG. 2A) across a folding axis (e.g., the folding axis F of FIG. 2A) of an electronic device (e.g., the electronic device 101 of FIG. 2A).

The POL 520, the display panel 530, the polymer member 540, and the support plate 550 may be bonded to each other via adhesive members P1, P2, and P3. For example, the adhesive members P1, P2, and P3 may include at least one of an optical clear adhesive (OCA), a pressure-sensitive adhesive (PSA), a heat-responsive adhesive, a general adhesive, and a double-sided tape. According to an embodiment, the flexible display 500 may include another adhesive member P4 (e.g., a double-sided tape or a waterproofing member) disposed along an edge on the rear surface of the support plate 550.

A dark color (e.g., black) may be applied to the polymer member 540, which may assist in background presentation when the display is turned off. The polymer member 540 may act as a cushion for preventing the flexible display 500 from being damaged by absorbing an impact from the exterior of the electronic device.

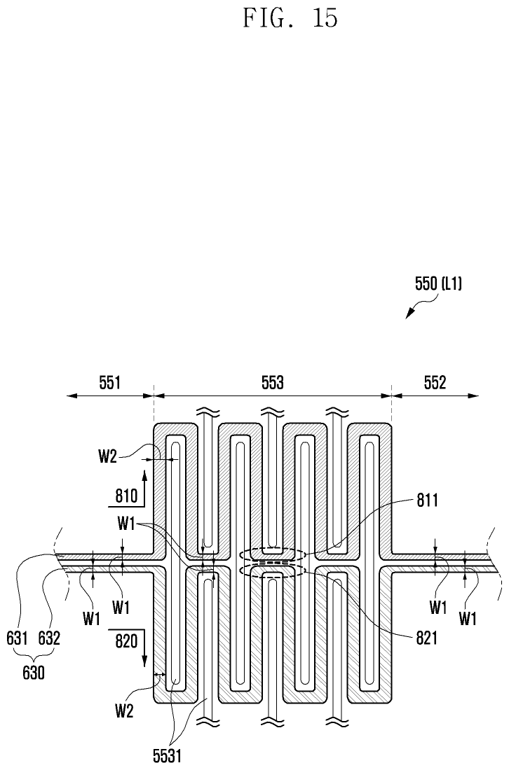

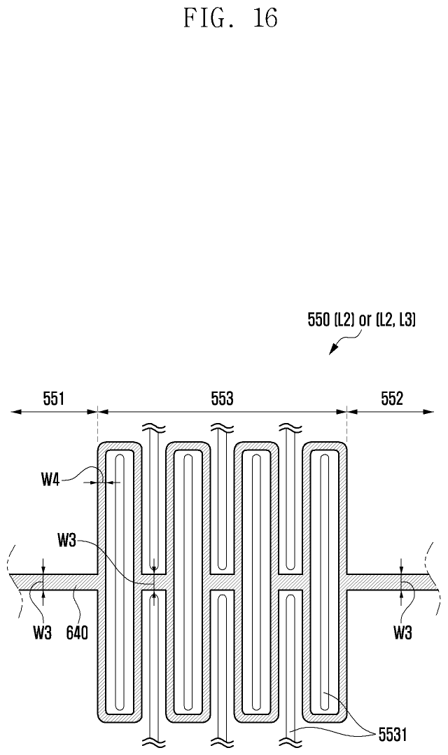

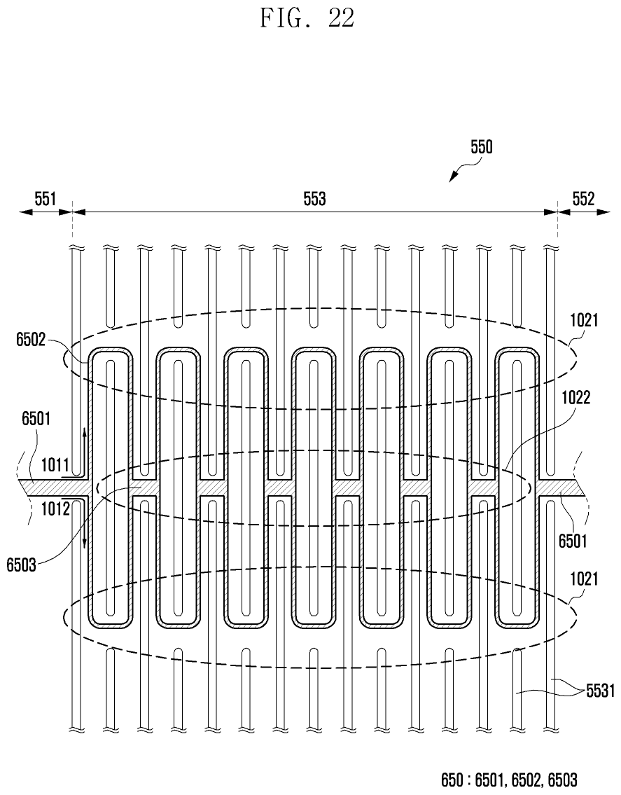

The support plate 550 may serve to support the display panel 530 and may include glass fiber reinforced plastic (GFRP) or carbon fiber reinforced plastic (CFRP). The support plate 550 may have a multi-layer structure including a plurality of layers, and a high-speed signal line (e.g., the differential signal line 630 of FIG. 15), a ground line (e.g., the ground line 640 of FIG. 16), and/or an RF signal line (e.g., the RF signal line 650 of FIG. 22) may be disposed in at least some of the plurality of layers. The high-speed signal line (e.g., a differential signal line), ground line, and RF signal line of the support plate 550 may serve to electrically connect some components (e.g., the first substrate 361 of FIG. 4) disposed in the first housing (e.g., the first housing 310 of FIG. 2A) and some components (e.g., the second substrate 362 of FIG. 4) disposed in the second housing (e.g., the second housing 320 of FIG. 2A). Accordingly, the electronic device (e.g., the electronic device 101 of FIG. 2A) may reduce or omit the use of a PCB or FPCB for signal transmission.

The support plate 550 may further include a metal sheet that may assist in reinforcing the rigidity of the electronic device 101 and that shields ambient noise and disperses heat emitted from heat-generating components (e.g., the processor 120 of FIG. 1) in the vicinity. According to an embodiment, the support plate 550 may include at least one metal sheet selected from copper (Cu), aluminum (Al), stainless steel (SUS), or a clad material (e.g., a laminated member in which SUS and Al are alternately stacked).

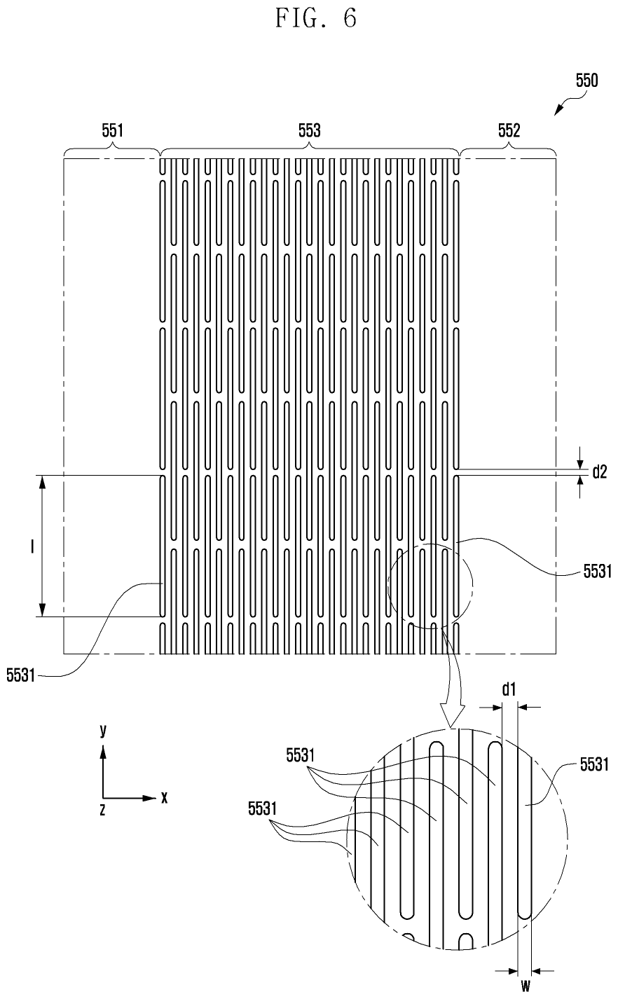

FIG. 6 is an enlarged plan view of a portion of the support plate illustrated in FIG. 5 according to an embodiment of the disclosure.

The support plate 550 of FIG. 6 may be at least partially similar to the support plate 550 of FIG. 5 or may further include other embodiments for the support plate 550.

Referring to FIG. 6, the support plate 550 may include a first flat portion 551 facing a first housing (e.g., the first housing 310 of FIG. 2A), a second flat portion 552 facing a second housing (e.g., the second housing 320 of FIG. 2A), and a bendable portion 553 disposed between the first flat portion 551 and the second flat portion 552 to face a hinge structure (e.g., the hinge structure 340 of FIG. 2B) and configured to be bendable via a plurality of openings 5531 arranged at intervals.

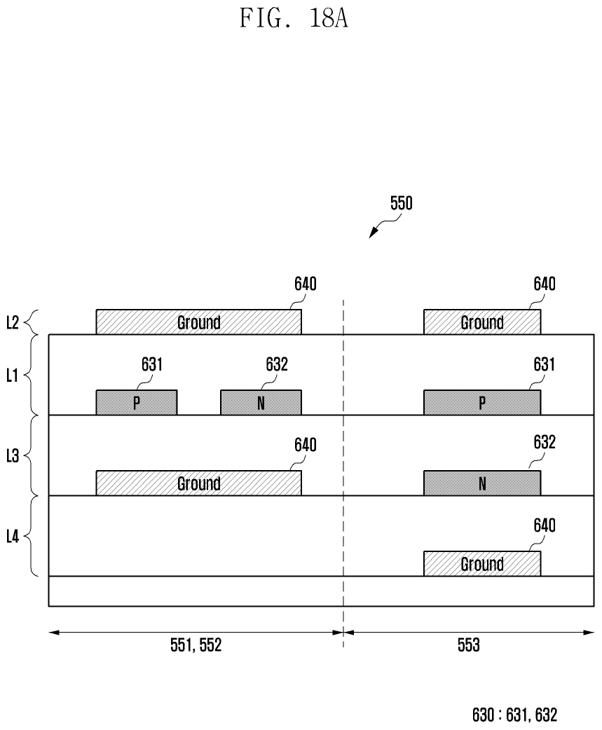

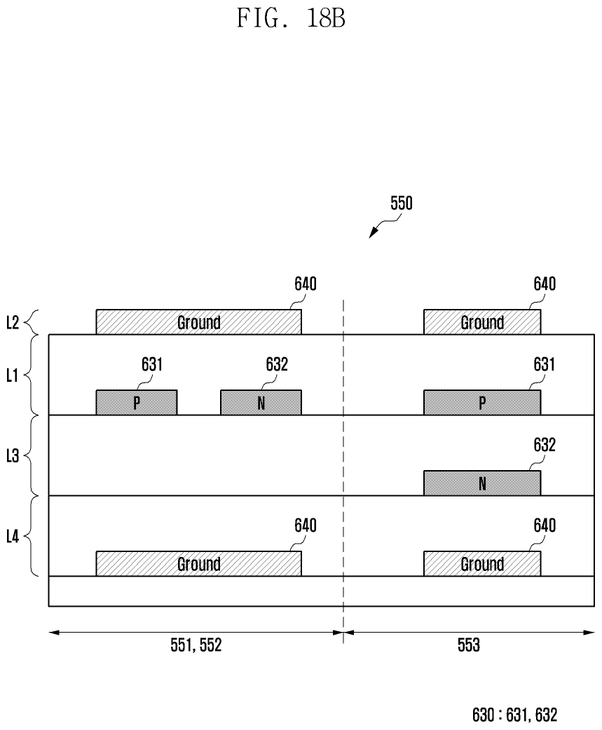

The bendable portion 553 may include the plurality of openings 5531 spaced apart from each other. The openings 5531 may refer to areas from which a metal material has been removed. For example, the support plate 550 may have a multi-layer structure including a plurality of layers, and a metal member for a high-speed signal line (e.g., the differential signal line 630 of FIG. 15), a ground line (e.g., the ground line 640 of FIG. 16), and/or an RF signal line (e.g., the RF signal line 650 of FIG. 22) may be disposed in at least some of the plurality of layers. The multi-layer structure of the support plate 550 will be described in detail with reference to FIGS. 18A, 18B, 19A, 19B, 20A, 20B, 21A, 21B, and 21C.

In the disclosure, the openings 5531 of the support plate 550 may refer to areas of the bendable portion 553 in which no metal member is disposed.

The plurality of openings 5531 may be arranged along a first direction (e.g., a longitudinal direction) (e.g., the y-axis direction) of the bendable portion 553 and a second direction (e.g., a width direction) (e.g., the x-axis direction) perpendicular to the first direction. The plurality of openings 5531 may have an elliptical shape elongated along the first direction (e.g., the y-axis direction) of the bendable portion 553. The plurality of openings 5531 may be arranged alternately in an aligned manner along the second direction (e.g., the x-axis direction) of the bendable portion 553. The plurality of openings 5531 may be arranged at regular or irregular intervals along the first direction (e.g., the y-axis direction) and/or the second direction (e.g., the x-axis direction). The plurality of openings 5531 may have the same shape or different shapes from one another. The bendable portion 553 may exhibit an elastic restoring force that tends to return to its original shape after being deformed, via a perforated lattice structure formed by the plurality of openings 5531, and such elastic restoring force may contribute to providing flexibility to the bendable portion.

The flexibility of the bendable portion 553 may be determined by the interval, shape, or arrangement density of the plurality of openings 5531. For example, the flexibility of the bendable portion 553 may be determined by the length l of a single opening (e.g., a unit opening). The flexibility of the bendable portion 553 may also be determined by the width w of a single opening. The flexibility of the bendable portion 553 may be determined by a first interval d1 between the openings 5531 formed along the second direction (e.g., the x-axis direction). The flexibility of the bendable portion 553 may be determined by a second interval d2 between the openings 5531 formed along the first direction (e.g., the y-axis direction).

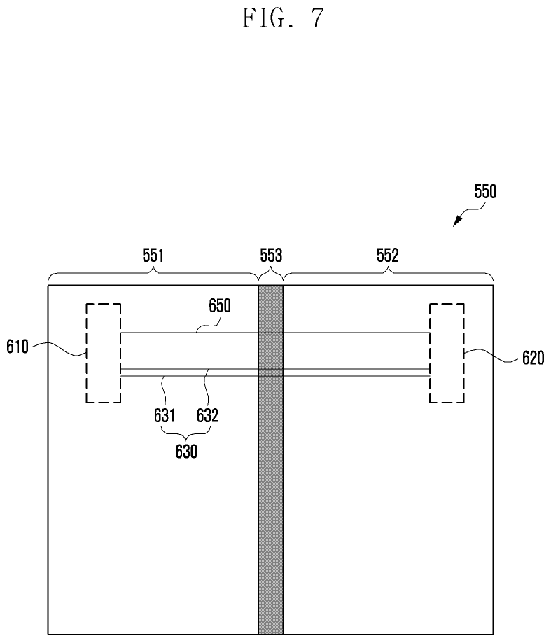

FIG. 7 is a plan view schematically illustrating a support plate according to an embodiment of the disclosure.

The support plate 550 of FIG. 7 may be at least partially similar to the support plate 550 of FIGS. 5 and 6 or may further include other embodiments for the support plate 550.

Referring to FIG. 7, the support plate 550 may include a high-speed signal line (e.g., a differential signal line 630) and an RF signal line 650. Although not illustrated, the support plate 550 may further include a ground line that serves as a reference plane. The ground line may extend to at least partially overlap the differential signal line 630. The ground line will be described in more detail with reference to FIGS. 16, 18A, 18B, 19A, 19B, 20A, 20B, 21A, 21B, and 21C.

The differential signal line 630, the ground line, and the RF signal line 650 may be disposed to extend from at least a portion of the first flat portion 551 to at least a portion of the second flat portion 552 across the bendable portion 553.

The differential signal line 630, the ground line, and the RF signal line 650 may serve to electrically connect a first component 610 (e.g., the first substrate 361 of FIG. 4) disposed in the first housing (e.g., the first housing 310 of FIG. 2A) and a second component 620 (e.g., the second substrate 362 of FIG. 4) disposed in the second housing (e.g., the second housing 320 of FIG. 2A). Accordingly, the electronic device (e.g., the electronic device 101 of FIG. 2A) may reduce or omit a PCB or FPCB for signal transmission.

The differential signal line 630 may include a pair of signal lines, including a first signal line 631 and a second signal line 632. In the disclosure, the first signal line 631 may be interchangeably referred to as a “positive signal line.” In the disclosure, the second signal line 632 may be interchangeably referred to as a “negative signal line.”

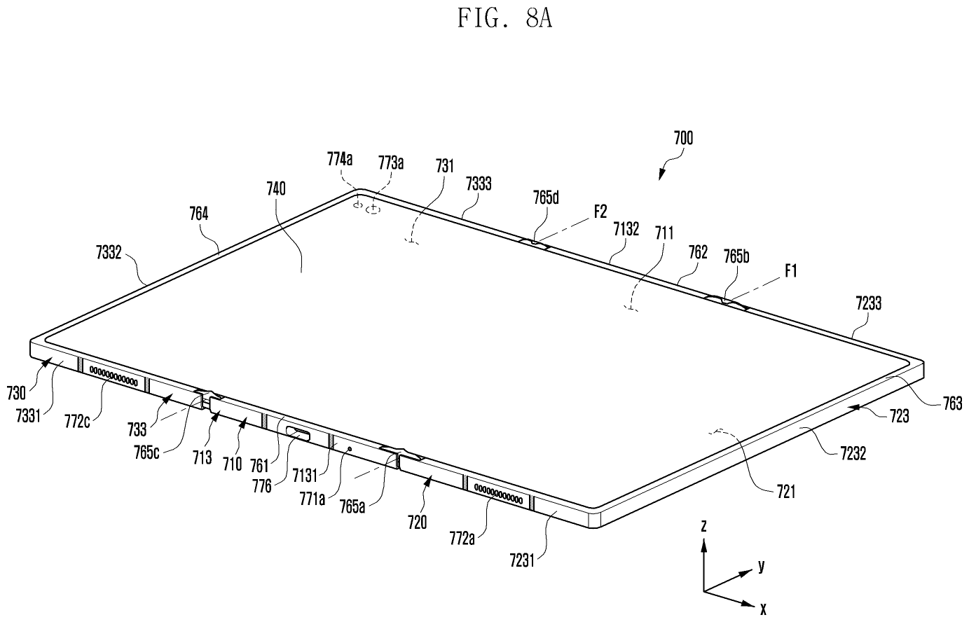

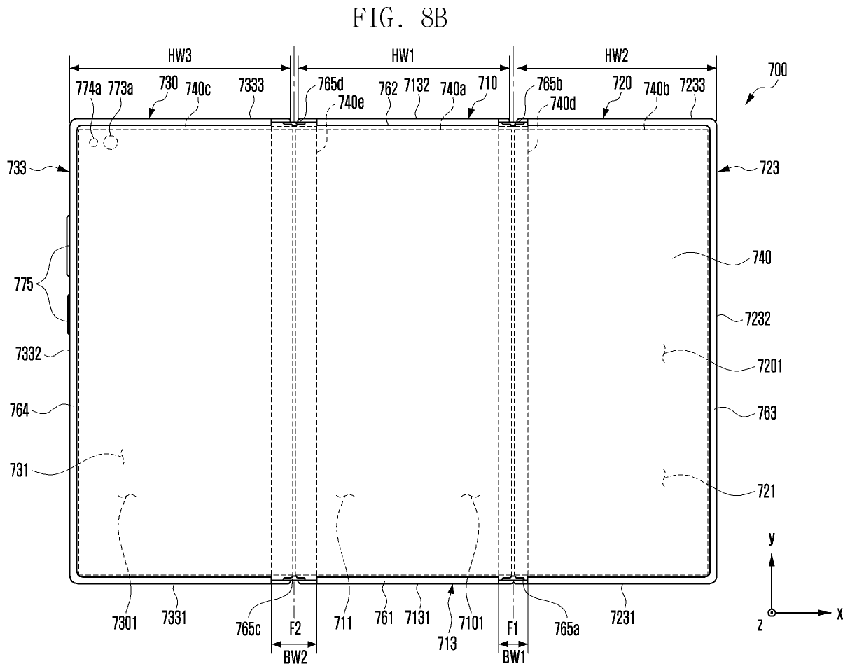

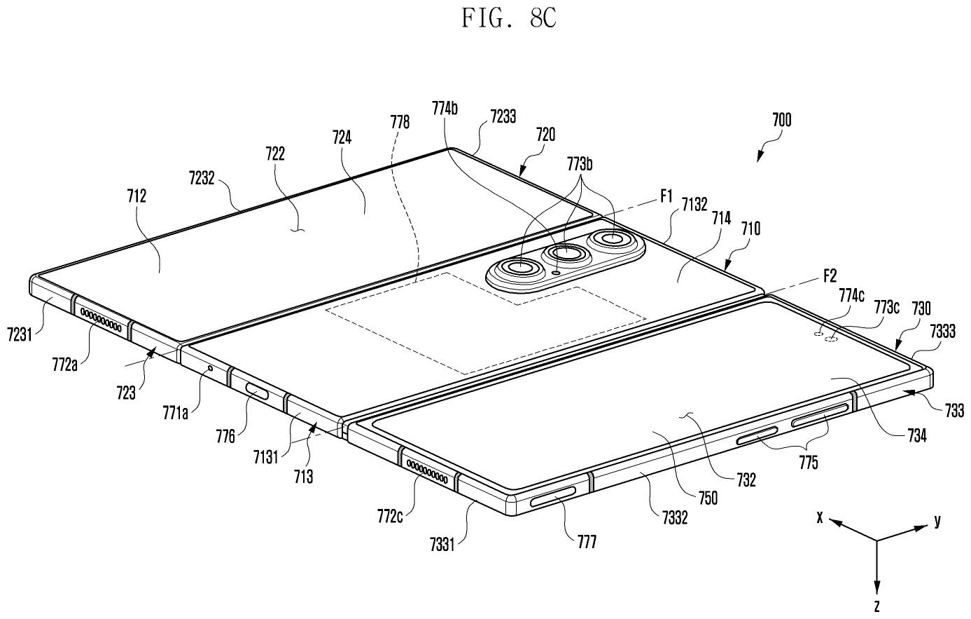

FIG. 8A is a front perspective view of a multi-foldable electronic device in a fully unfolded state according to an embodiment of the disclosure. FIG. 8B is a plan view of the multi-foldable electronic device in the fully unfolded state according to an embodiment of the disclosure. FIG. 8C is a rear perspective view of the multi-foldable electronic device in the fully unfolded state according to an embodiment of the disclosure.

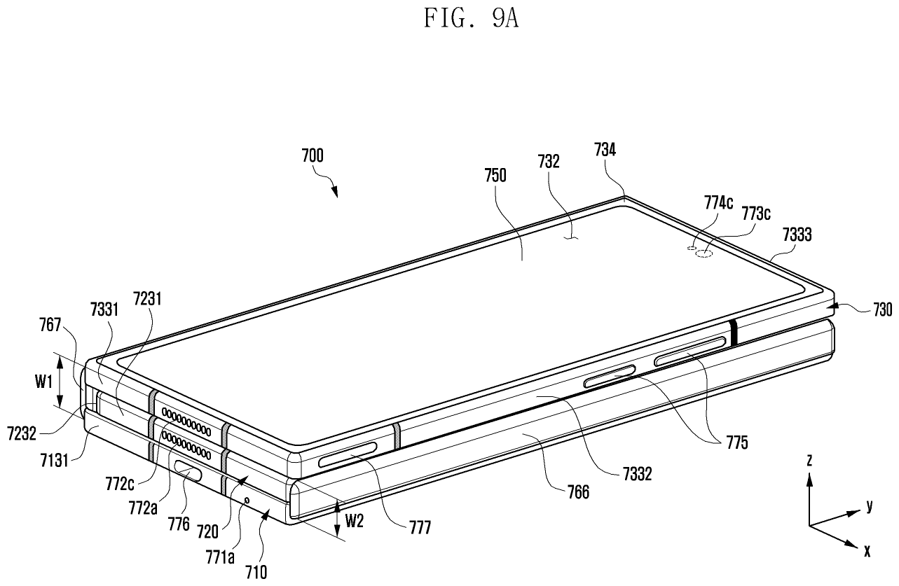

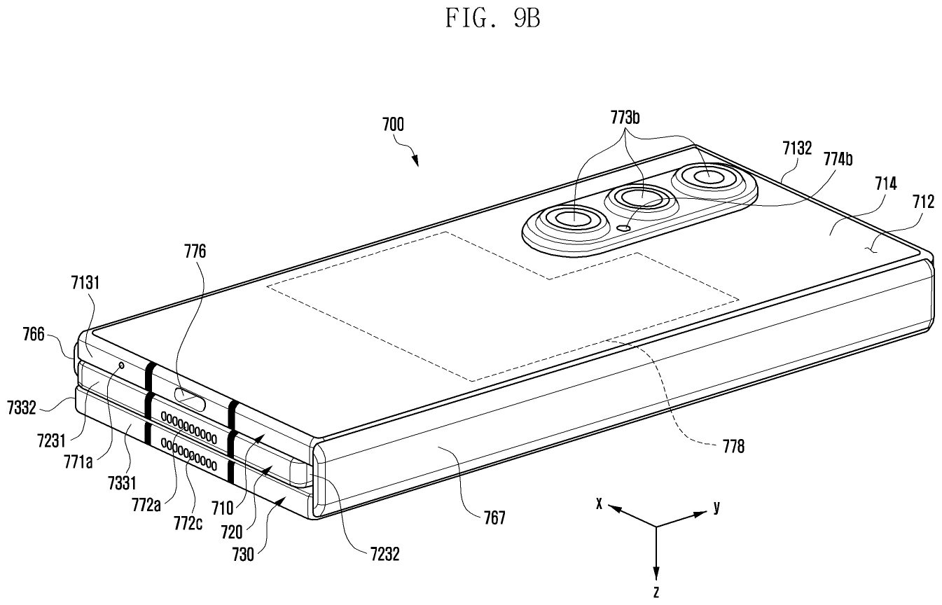

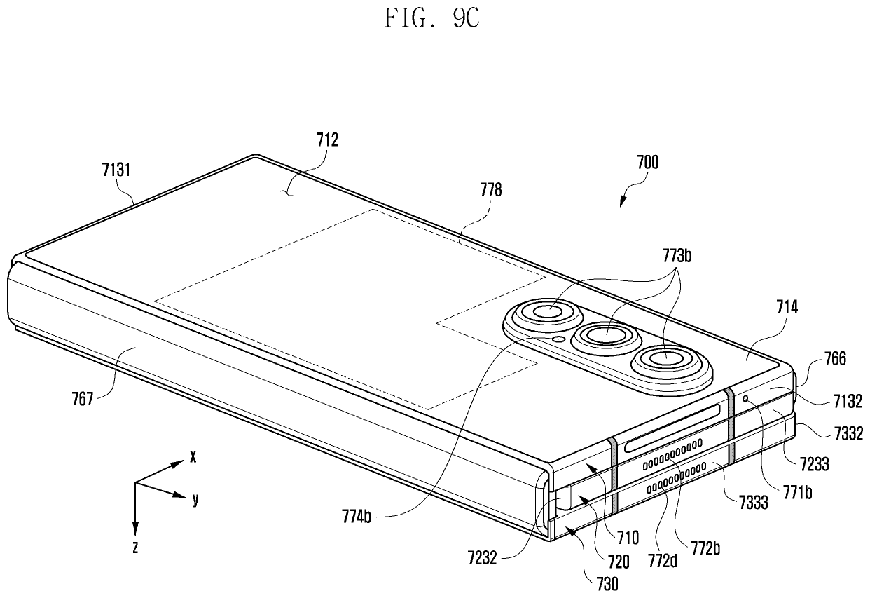

FIG. 9A is a front perspective view of a multi-foldable electronic device in a fully folded state according to an embodiment of the disclosure. FIGS. 9B and 9C are perspective views illustrating the multi-foldable electronic device, in which the rear surface of the multi-foldable electronic device is shown in various directions in the fully folded state according to various embodiments of the disclosure.

The multi-foldable electronic device 700 of FIGS. 8A to 8C and 9A to 9C may be at least partially similar to the electronic device 101 of FIG. 1 or may further include other embodiments for the multi-foldable electronic device.

Referring to FIGS. 8A to 8C and 9A to 9C, the multi-foldable electronic device 700 (e.g., a portable communication device or an electronic device) (e.g., the electronic device 101 of FIG. 1) may include a first housing 710 (e.g., a first housing unit), a second housing 720 (e.g., a second housing unit) rotatably connected to one side (e.g., the right side) of the first housing 710 in a direction (e.g., the x-axis direction) with respect to a first folding axis F1, and a third housing 730 (e.g., a third housing unit) rotatably connected to the other side (e.g., the left side) of the first housing 710 in a direction (e.g., the −x-axis direction) with respect to a second folding axis F2. The multi-foldable electronic device 700 may include a first hinge housing 766 configured to accommodate at least one first hinge module (e.g., a first hinge device or first hinge structure) connecting the first housing 710 and the second housing 720, and a second hinge housing 767 configured to accommodate at least one second hinge module (e.g., a second hinge device or second hinge structure) connecting the first housing 710 and the third housing 730. The first hinge housing 766 may cover the first hinge module such that the first hinge module is invisible from the outside while the first housing 710 and the second housing 720 are in the fully folded state or are being folded. The first hinge housing 766 may be arranged to be invisible from the outside when the first housing 710 and the second housing 720 are in the fully unfolded state. The second hinge housing 767 may cover the second hinge module such that the second hinge module is invisible from the outside while the first housing 710 and the third housing 730 are in the fully folded state or are being folded. The second hinge housing 767 may be arranged to be invisible from the outside when the first housing 710 and the third housing 730 are in the fully unfolded state. The multi-foldable electronic device 700 may include a foldable housing (e.g., a multi-foldable housing) configured with the first housing 710, the second housing 720, the third housing 730, the first hinge housing 766, and the second hinge housing 767. In some embodiments, the multi-foldable electronic device 700 may include a foldable housing configured with the first housing 710, the second housing 720, and the third housing 730. The multi-foldable electronic device 700 may include a flexible display 740 (e.g., a first display) disposed to be supported on the first housing 710, the second housing 720, and the third housing 730. The multi-foldable electronic device 700 may include a sub-display 750 (e.g., a second display) disposed through the third housing 730. Herein, the surface on which the flexible display 740 is disposed may be defined as the front surface of the multi-foldable electronic device 700, and the surface opposite to the front surface may be defined as the rear surface of the multi-foldable electronic device 700. The surface surrounding the space between the front surface and the rear surface may be defined as the side surface of the electronic device 700. Herein, a state in which the first housing 710, the second housing 720, and the third housing 730 of the multi-foldable electronic device 700 are fully unfolded may be defined as a “first state” or a “fully unfolded state,” a state in which the first housing 710, the second housing 720, and the third housing 730 are fully folded with respect to each other may be defined as a “second state” or a “fully folded state,” and a state in which only the first housing 710 and the second housing 720 are folded with respect to each other may be defined as a “third state” or an “intermediate state.”

The first housing 710 may include a first surface 711, a second surface 712 facing away from the first surface 711, and a first side surface member 713 surrounding a first space 7101 between the first surface 711 and the second surface 712. At least a portion of the first side surface member 713 may form at least a portion of the side surface of the multi-foldable electronic device 700. The first side surface member 713 may include a first side surface 7131 and a second side surface 7132 disposed at a position opposite to the first side surface 7131. The first housing 710 may include a first rear surface cover 714 coupled to the first side surface member 713. In an embodiment, the first space 7101 may be defined by a first rear surface cover 714 coupled to the first side surface member 713 on the second surface 712 of the first housing 710.

The second housing 720 may include a third surface 721, a fourth surface 722 facing away from the third surface 721, and a second side surface member 723 surrounding a second space 7201 between the third surface 721 and the fourth surface 722. At least a portion of the second side surface member 723 may form at least a portion of the side surface of the multi-foldable electronic device 700. The second side surface member 723 may include a third side surface 7231, a fourth side surface 7232 extending from the third side surface 7231 in a direction perpendicular to the same, and a fifth side surface 7233 extending from the fourth side surface 7232 and parallel to the third side surface 7231. The second housing 720 may include a second rear surface cover 724 coupled to the second side surface member 723. The sub-display 750 may alternatively be disposed through at least a portion of the second rear surface cover 724 in the second housing 720. In some embodiments, the multi-foldable electronic device 700 may further include an additional sub-display disposed through at least a portion of the second rear surface cover 724 in the second housing 720. In such a case, when the first housing 710 and the second housing 720 are fully folded and the third housing 730 is partially folded (e.g., folded at an angle of about 90 degrees with respect to the first housing 710), the sub-display disposed on the fourth surface 722 of the second housing 720 may be disposed to be visible from the exterior. The second space 7201 may be defined by a second rear surface cover 724 coupled to the second side surface member 723 on the fourth surface 722.

The third housing 730 may include a fifth surface 731, a sixth surface 732 facing away from the fifth surface 731, and a third side surface member 733 surrounding a third space 7301 between the fifth surface 731 and the sixth surface 732. At least a portion of the third side surface member 733 may form at least a portion of the side surface of the multi-foldable electronic device 700. The third side surface member 733 may include a sixth side surface 7331, a seventh side surface 7332 extending from the sixth side surface 7331 in a direction perpendicular to the same, and an eighth side surface 7333 extending from the seventh side surface 7332 and parallel to the sixth side surface 7331. The third space 7301 may be defined by a third rear surface cover 734 coupled to the third side surface member 733 on the sixth surface 7331.

The first side surface 7131, the third side surface 7231, and the sixth side surface 7331 may form the same side surface (e.g., the lower side surface) of the multi-foldable electronic device 700. The second side surface 7132, the fifth side surface 7233, and the eighth side surface 7333 may form the same side surface (e.g., the upper side surface) of the multi-foldable electronic device 700. The fourth side surface 7232 may form one side surface (e.g., the right side surface) of the multi-foldable electronic device 700. In an embodiment, the seventh side surface 7332 may form one side surface (e.g., the left side surface) of the multi-foldable electronic device 700.

The multi-foldable electronic device 700 may be configured such that, in the fully unfolded state (e.g., the first state), the first housing 710, the second housing 720, and the third housing 730 are positioned side by side so that the first surface 711, the third surface 721, and the fifth surface 731 are oriented in the same direction. The multi-foldable electronic device 700 may be configured such that, in the fully folded state (e.g., the second state), the first housing 710, the second housing 720, and the third housing 730 are positioned to be sequentially stacked so that the first surface 711 and the third surface 721 face each other, and the fourth surface 722 and the fifth surface 731 face each other. In this case, the second surface 712 and the sixth surface 732 may be positioned to be visible from the outside, and the third surface 721 and the fourth surface 722 may be positioned to be invisible through the first housing 710 and the third housing 730. The sub-display 750 may be disposed to be visible from the outside through at least a portion of the sixth surface 732 in the unfolded and/or folded state.

According to various embodiments, the multi-foldable electronic device 700 may include at least one housing, including the first housing 710, the second housing 720, and the third housing 730, and the configuration in which the housings 710, 720, and 730 are foldably coupled to each other may be variously modified. The disclosure is not limited to the examples of FIGS. 8A to 8C and 9A to 9C in terms of the manner in which the first housing 710, the second housing 720, and the third housing 730 are foldably coupled to each other, and may be variously modified. According to an embodiment, the first housing 710, the second housing 720, and the third housing 730 may have different sizes from each other. The first housing 710 may have a first width HW1, the second housing 720 may have a second width HW2 that is smaller than the first width HW1, and the third housing 730 may have a third width HW3 that is larger than the first width HW1. For example, through definition of the widths HW1, HW2, and HW3 of the housings 710, 720, and 730, the multi-foldable electronic device 700 may be configured such that none of the housings protrude outward in the fully folded state, thereby helping to provide an aesthetic appearance and improve portability. However, the disclosure is not limited to this, and at least two of the first, second, and third widths HW1, HW2, and HW3 may be configured to be equal to each other.

The flexible display 740 may include a first area 740a corresponding to at least a portion of the first housing 710, a second area 740b extending from one side (e.g., the right side) of the first area 740a and corresponding to at least a portion of the second housing 720, and a third area 740c extending from the other side (e.g., the left side) of the first area 740a and corresponding to at least a portion of the third housing 730. The flexible display 740 may include a bendable fourth area 740d (e.g., a first folding area) that includes a portion of the first area 740a and a portion of the second area 740b and corresponds to the first hinge assembly HA1, and a bendable fifth area 740e (e.g., a second folding area) that includes a portion of the first area 740a and a portion of the third area 740c and corresponds to the second hinge assembly HA2. The area division of the flexible display 740 is only an example; the flexible display 740 may be displayed as a substantially seamless single entire screen. The first area 740a and the second area 740b may have an overall symmetric shape or a partially asymmetric shape with respect to the fourth area 740d and/or the first folding axis F1. The first area 740a and the third area 740c may have an overall symmetric shape or a partially asymmetric shape with respect to the fifth area 740e and/or the second folding axis F2. In a direction perpendicular to the first folding axis F1 (e.g., the x-axis direction), a first folding width BW1 of the fourth area 740d may be smaller than a second folding width BW2 of the fifth area 740e. In some embodiments, the area of the fourth area 740d may be smaller than the area of the fifth area 740e. This may be due to the fact that the first hinge assembly HA1 interconnecting the first housing 710 and the second housing 720 and the second hinge assembly HA2 interconnecting the first housing 710 and the third housing 730 differ from each other. For example, the size of at least one first hinge module (e.g., a narrow hinge module) of the first hinge assembly HA1 interconnecting the first housing 710 and the second housing 720 may be smaller than the size of at least one second hinge module (e.g., a wide hinge module) of the second hinge assembly HA2 interconnecting the first housing 710 and the third housing 730 and folding the flexible display 740 in the fully folded state. With this configuration, the second hinge housing 767 may have a first accommodation width W1 larger than the thickness of the first housing 710, and the first hinge housing 766 may have a second accommodation width W2 smaller than the first accommodation width W1.

The electronic device 700 may include a first rear surface cover 714 disposed on the second surface 712 of the first housing 710, a second rear surface cover 724 disposed on the fourth surface 722 of the second housing 720, and a third rear surface cover 734 disposed on the sixth surface 732 of the third housing 730. In some embodiments, at least a portion of the first rear surface cover 714 may be formed integrally with the first side surface member 713. In some embodiments, at least a portion of the second rear surface cover 724 may be integrated with the second side surface member 723. In some embodiments, at least a portion of the third rear surface cover 734 may be formed integrally with the third side surface member 733. At least one of the first rear surface cover 714, the second rear surface cover 724, and the third rear surface cover 734 may be made of a substantially transparent plate (e.g., a glass plate including various coating layers, or a polymer plate) or an opaque plate. According to an embodiment of the disclosure, the first rear surface cover 714 and the second rear surface cover 724 may be made of, for example, coated or colored glass, ceramic, polymer, metal (e.g., aluminum, stainless steel (STS), or magnesium), or an opaque plate such as a combination of two or more of these materials. In an embodiment, the third rear surface cover 734 may be made of a substantially transparent plate of, for example, glass or polymer. Accordingly, the sub-display 750 may be disposed in the third space 7301 of the third housing 730 to be visible from the outside through the third rear surface cover 734.

The multi-foldable electronic device 700 may include a first protection frame 761 (e.g., a first decoration member) and a second protection frame 762 (e.g., a second decoration member) disposed in the first housing 710 to cover edges of the first area 740a of the flexible display 740. The first protection frame 761 may be disposed along the first side surface 7131 and the second protection frame 762 may be disposed along the second side surface 7132, in the first housing 710. The edge of the flexible display 740 corresponding to the first housing 710 may be concealed by the first and second protection frames 761 and 762 to be invisible from the outside. The multi-foldable electronic device 700 may include a third protection frame 763 (e.g., a third decorative member) disposed in the second housing 720 to cover the edge of the second area 740b of the flexible display 740. The third protection frame 763 may be disposed along the third side surface 7231, the fourth side surface 7232, and the fifth side surface 7233 in the second housing 720. The edge of the flexible display 740 corresponding to the second housing 720 may be concealed by the third protection frame 763 to be invisible from the outside. The multi-foldable electronic device 700 may include a fourth protection frame 764 (e.g., a fourth decorative member) disposed in the third housing 730 to cover the edge of the third area 740c of the flexible display 740. The fourth protection frame 764 may be disposed along the sixth side surface 7331, the seventh side surface 7332, and the eighth side surface 7333 in the third housing 730. In an embodiment, the edge of the flexible display 740 corresponding to the third housing 730 may be concealed by the fourth protection frame 764 to be invisible from the outside. In some embodiments, at least one protection frame may be omitted among the first, second, third, and fourth protection frames 761, 762, 763, and 764.

The multi-foldable electronic device 700 may include a first protection member 765a (e.g., a first protection cap) disposed between a first protection frame 761 and a third protection frame 763 in the fourth area 740d and disposed to cover at least a portion of an edge of the flexible display 740, and a second protection member 765b disposed between a second protection frame 762 and the third protection frame 763 and disposed to cover at least a portion of an edge of the flexible display 740. The multi-foldable electronic device 700 may include a third protection member 765c (e.g., a third protection cap) disposed between the first protection frame 761 and a fourth protection frame 764 in the fifth area 740e and disposed to cover at least a portion of an edge of the flexible display 740, and a fourth protection member 765d disposed between the second protection frame 762 and the fourth protection frame 764 and disposed to cover at least a portion of an edge of the flexible display 740. According to an embodiment of the disclosure, at least one of the first, second, third, and fourth protection members 765a, 765b, 765c, and 765d may be omitted.

The electronic device 700 may include at least one electronic component disposed in at least one of the first space 7101 of the first housing 710, the second space 7201 of the second housing 720, and/or the third space 7301 of the third housing 730. The at least one electronic component may include a flexible display 740 (e.g., a first display) disposed through the first housing 710, the second housing 720, and the third housing 730, a sub-display 750 (e.g., a second display) disposed in the third housing 730, one or more microphones 771a and 771b (e.g., an input module or input device), one or more speakers 772a, 772b, 772c, and 772d (e.g., a sound output module or sound output device), one or more cameras 773a, 773b, and 773c (e.g., a camera module or camera device), one or more sensors 774a, 774b, and 774c (e.g., a sensor module), at least one key button 775 (e.g., an input device or physical key), a connector port 776, or a socket device 777. In some embodiments, the electronic device 700 may additionally include at least one other component. In some embodiments, at least one of the above-described components may be omitted.

The flexible display 740 may be disposed in an accommodation space defined by the housings 710, 720, and 730. For example, the flexible display 740 may be disposed in a recess defined by the housings 710, 720, and 730, and may be disposed to occupy substantially most of the front surface of the electronic device 200 in the fully unfolded state. The sub-display 750 may be disposed in the third space 7301 of the third housing 730 to be visible from the outside through the third rear surface cover 734.

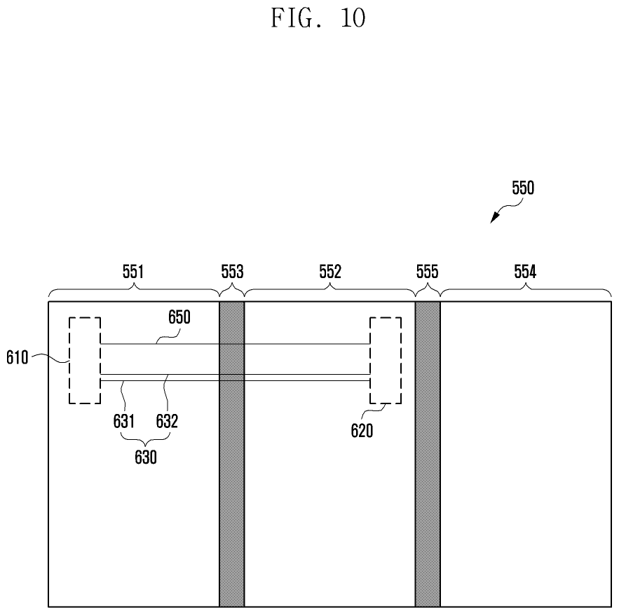

The flexible display 740 may be at least partially similar to the flexible display 500 of FIG. 5 or may include other embodiments of a flexible display. For example, the flexible display 740 may include the support plate 550 (e.g., the support plate 550 of FIG. 10) described with reference to FIGS. 5 and 6, and the support plate 550 of the flexible display 740 may include a high-speed signal line (e.g., a differential signal line 630) and an RF signal line 650. The support plate 550 of the flexible display 740 will be described in more detail below with reference to FIGS. 10 to 13.

The one or more microphones 771a and 771b may include a first microphone 771a disposed through the first side surface 7131 of the first housing 710 and a second microphone 771b disposed through the second side surface 7132 of the first housing 710. In some embodiments, the one or more microphones 771a and 771b may be disposed on the third side surface 7231 and/or the fifth side surface 7233 of the second housing 720. In other embodiments, the one or more microphones 771a and 771b may be disposed on the sixth side surface 7331 and/or the eighth side surface 7333 of the third housing 730.

The one or more speakers 772a, 772b, 772c, and 772d may include a first speaker 772a disposed to emit sound through the third side surface 7231 of the second housing 720, a second speaker 772b disposed to emit sound through the fifth side surface 7233, a third speaker 772c disposed to emit sound through the sixth side surface 7331 of the third housing 730, and a fourth speaker 772d disposed to emit sound through the eighth side surface 7333. The one or more speakers 772a, 772b, 772c, and 772d may be arranged symmetrically to implement stereo sound (e.g., three-dimensional sound) in the unfolded or folded state of the multi-foldable electronic device 700. In the fully folded state, the second speaker 772b or the fourth speaker 772d may be placed near the user's ear and may be used as a call receiver. In some embodiments, the multi-foldable electronic device 700 may further include an additional receiver (not illustrated) disposed in the third space 7301 of the third housing 730 and disposed to emit sound through a speaker hole provided in at least a portion of the third rear surface cover 734 or between the third rear surface cover 734 and the third side surface member 733. In some embodiments, the one or more speakers 772a, 772b, 772c, and 772d may be replaced with a piezo speaker that operates without a hole formed in the second housing 720 and/or the third housing 730.

The one or more cameras 773a, 773b, and 773c may include a first camera 773a disposed in the third space 7301 of the third housing 730 through the fifth surface 731 of the third housing 730, a second camera 773b disposed through the second surface 712 of the first housing 710, and a third camera 773c disposed through the sixth surface 732 of the third housing 730. The least one camera 773a, 773b, and 773c may include one or more lenses, an image sensor, and/or an image signal processor. In some embodiments, the least one cameras 773a, 773b, and 773c may include two or more lenses (e.g., wide-angle and telephoto lenses) and image sensors, and may be disposed together on one surface of one of the first housing 710, the second housing 720, or the third housings 730. According to an embodiment of the disclosure, the multi-foldable electronic device 700 may include a flash (not illustrated) disposed near the second camera 773b. In an embodiment, the flash may include, for example, a light-emitting diode or a xenon lamp.

The one or more sensors 774a, 774b, and 774c may generate electrical signals or data values corresponding to the internal operating state or the external environmental state of the multi-foldable electronic device 700. The one or more sensors 774a, 774b, and 774c may include a first sensor 774a disposed on the fifth surface 731 of the third housing 710, a second sensor 774b disposed on the second surface 712 of the first housing 710, and/or a third sensor 774c disposed on the sixth surface 732 of the third housing 730. For example, the one or more sensors 774a, 774b, and 774c may include at least one of a gesture sensor, a grip sensor, a color sensor, an infrared (IR) sensor, an illumination sensor, an ultrasonic sensor, an iris recognition sensor, and a distance detection sensor (e.g., a time-of-flight (TOF) sensor or a light detection and ranging (LiDAR) sensor). According to an embodiment of the disclosure, the multi-foldable electronic device 700 may further include, for example, at least one of an air pressure sensor, a magnetic sensor, a biometric sensor, a temperature sensor, a humidity sensor, or a fingerprint recognition sensor, as at least one sensor (not illustrated). In some embodiments, the fingerprint sensor may be positioned to detect a user's fingerprint through at least a portion of the key button 775.

The one or more cameras 773a, 773b, and 773c and/or the one or more sensors 774a, 774b, and 774c may be disposed to detect the external environment through the flexible display 740 and/or sub-display 750. For example, the one or more cameras 773a, 773b, and 773c and/or the one or more sensors 774a, 774b, and 774c may be disposed in the first space 7101 of the first housing 730 and/or the third space 7301 of the third housing 710 below the non-active display area or active display area of the flexible display 740 and/or sub-display 750, and may be disposed to come into contact with the external environment through a transparent area or an opening perforated to a cover member (e.g., a window layer) and/or the third rear surface cover 734. The area corresponding to the one or more cameras 773a and 773c of the flexible display 740 and/or the sub-display 750 may be formed as a transmission area with a certain transmittance as a portion of a content display area. The transmission area may have a transmittance ranging from about 5% to about 30%. The transmission area may include an area overlapping the effective area (e.g., a view angle area) of the one or more cameras 773a and 773c through which light for forming an image by an image sensor passes. For example, the transmission area of the flexible display 740 and/or the sub-display 750 may include an area where pixel placement density is lower than that of the surrounding area. According to an embodiment of the disclosure, the transmission area may be replaced with an opening. For example, the one or more cameras 773a and 773c may include an under-display camera (UDC) or an under-panel camera (UPC). In an embodiment, some cameras 773a and 773c or some sensors 774a and 774c may be disposed to perform their functions without being visually exposed through the flexible display 740 and/or sub-display 750. For example, the area of the flexible display 740 and/or the sub-display 750 corresponding to the one or more cameras 773a and 773c and/or the one or more sensors 774a and 774c may not require a perforated opening.

At least one key button 775 may be disposed on the seventh side surface 7332 of the third housing 730. According to this, when the multi-foldable electronic device 700 is in a fully folded state, the sixth surface 732 faces upward to use the sub-display 750, and at least one key button 775 is located on the right side surface, which may help improve convenience of use. In some embodiments, the multi-foldable electronic device 700 some or all of the one or more key buttons 775 may be omitted, and the key buttons not included in the multi-foldable electronic device may be implemented in other forms such as soft keys displayed on the flexible display 740 and/or the sub-display 750. In some embodiments, some of the one or more key buttons 775 may be implemented using one more pressure sensors implemented through the flexible display 740 and/or the sub-display 750. The one or more key buttons 775 may be disposed on at least one of the first side surface 7131 or the second side surface 7132 of the first housing 710, the third side surface 7231 or the fifth side surface 7233 of the second housing 720, and/or the sixth side surface 7331 or the eighth side surface 7333 of the third housing 730, which may be used even when the multi-foldable electronic device 700 is in the fully folded state and/or the fully unfolded state.

The connector port 776 may be disposed through the first side surface 7131 of the first housing 710. The connector ports 776 may include a connector (e.g., a USB connector or an interface connector port module (IF module)) structure configured to transmit/receive power and/or data to/from an external electronic device. The connector ports 776 may further include a separate connector port (e.g., an ear jack hole) for performing a function to transmit/receive an audio signal together with an external electronic device or for performing a function to transmit/receive an audio signal. The connector port 776 may be disposed on at least one of the second side surface 7132 of the first housing 710, the third side surface 7231, the fourth side surface 7232, or the fifth side surface 7233 of the second housing 720, and/or the sixth side surface 7331, the seventh side surface 7332, or the eighth side surface 7333 of the third housing 730, which may be used even when the multi-foldable electronic device 700 is in the fully folded state and/or the fully unfolded state.

The socket device 777 may be disposed on the seventh side surface 7332 of the third housing 730 such that the multi-foldable electronic device 700 may be used even in the fully folded state. The socket device 777 may include a tray movably coupled to the seventh side surface 7332 to be extendable and retractable so as to accommodate a SIM card or an external memory card. The socket device 777 may be disposed on the sixth side surface 7331 and/or the eighth side surface 7333 of the third housing 730. The socket device 777 may be disposed on one side surface of the first housing 710 (e.g., at least one of the first side surface 7131 or the second side surface 7132 of FIG. 8B) or on one side surface of the second housing 720 (e.g., at least one of the third side surface 7231, fourth side surface 7232, or fifth side surface 7233 of FIG. 8B).

At least one of the one or more microphones 771a and 771b, the one or more speakers 772a, 772b, 772c, and 772d, the one or more key buttons 775, the connector port 776, or the socket device 777 may be exposed to the external environment through at least one hole (e.g., a through hole) formed in the first housing 710, the second housing 720, and/or the third housing 730.

The multi-foldable electronic device 700 may include an antenna member 778 disposed in the first space 7101 of the first housing 710. In an embodiment, the antenna member 778 may be disposed to transmit or receive RF signals through the second surface 712 of the first housing 710 such that the multi-foldable electronic device 700 is operable even in the fully folded state. The antenna member 778 may include an antenna operating in near-field communication (NFC), multi-function coil or multi-function core (MFC), and/or magnetic secure transmission (MST) modes to perform wireless charging, electronic payment, and/or data transmission/reception functions. The antenna member 778 may include an ultra-wide band (UWB) antenna used to detect the distance to or the location of an external electronic device (e.g., an angle-of-arrival (AoA) positioning technique).

Through the folding operation of the first housing 710, the second housing 720, and the third housing 730, the multi-foldable electronic device 700 according to various embodiments of the disclosure may allow a large display area to be used in the fully unfolded state, and is transformed in the fully folded state in such a way that the three housings 710, 720, and 730 overlap each other, which may help improve portability. In addition, a plurality of electronic components may be disposed at appropriate positions that are advantageous for use in the fully unfolded state and/or the fully folded state of the multi-foldable electronic device 700, which may help improve convenience of use.

FIGS. 10, 11, 12, and 13 are plan views each schematically illustrating a support plate 550 of a multi-foldable electronic device in an unfolded state according to various embodiments of the disclosure.

The support plate 550 of FIGS. 10 to 13 may be a component included in the flexible display (e.g., the flexible display 740 of FIG. 8A) of the multi-foldable electronic device (e.g., the electronic device 700 of FIG. 8A) described with reference to FIGS. 8A to 8C and 9A to 9C. For example, the support plate 550 of FIGS. 10 to 13 may be a component that forms the rear surface of the flexible display 740 of FIG. 8A.

The support plate 550 of FIGS. 10 to 13 may be at least partially similar to the support plate 550 of FIGS. 5, 6, and 7, or may further include other embodiments for the support plate 550.

Referring to FIG. 10, the support plate 550 (e.g., the support plate 550 of FIG. 6) may include a first flat portion 551, a second flat portion 552, and a third flat portion 554. The second flat portion 552 may be disposed between the first flat portion 551 and the third flat portion 554.

The second flat portion 552 may be an area facing the first housing (e.g., the first housing 710 of FIG. 8A) of the multi-foldable electronic device (e.g., the electronic device 700 of FIG. 8A) described with reference to FIGS. 8A to 8C and 9A to 9C.

The first flat portion 551 may be an area facing the third housing (e.g., the third housing 730 of FIG. 8A) of the multi-foldable electronic device (e.g., the electronic device 700 of FIG. 8A) described with reference to FIGS. 8A to 8C and 9A to 9C.

The third flat portion 554 may be an area facing the second housing (e.g., the second housing 720 of FIG. 8A) of the multi-foldable electronic device (e.g., the electronic device 700 of FIG. 8A) described with reference to FIGS. 8A to 8C and 9A to 9C.

A first bendable portion 553 may be disposed between the first flat portion 551 and the second flat portion 552, and the first bendable portion 553 may have flexibility by including openings 5531 that are at least partially similar to the openings 5531 of the bendable portion 553 described with reference to FIG. 5.

A second bendable portion 555 may be disposed between the second flat portion 552 and the third flat portion 554, and the second bendable portion 555 may have flexibility by including openings 5531 that are at least partially similar to the openings 5531 of the bendable portion 553 described with reference to FIG. 5.

The support plate 550 may include a high-speed signal line (e.g., a differential signal line 630), a power line (not illustrated), and/or an RF signal line 650. Although not illustrated, the support plate 550 may further include a ground line (e.g., the ground line 640 of FIG. 16) serving as a reference plane. The ground line may extend to at least partially overlap the differential signal line 630.

The differential signal line 630, the ground line, and the RF signal line 650 may be disposed to extend from at least a portion of the first flat portion 551 to at least a portion of the second flat portion 552 across the first bendable portion 553.

The differential signal line 630, the ground line, and the RF signal line 650 may serve to electrically connect a first component 610 (e.g., a first substrate) disposed in the third housing (e.g., the third housing 730 of FIG. 8A) and a second component 620 (e.g., a second substrate) disposed in the first housing (e.g., the first housing 710 of FIG. 8A). Accordingly, the multi-foldable electronic device (e.g., the multi-foldable electronic device 700 of FIG. 8A) may reduce or omit a PCB or an FPCB used for signal transmission.

According to an embodiment of the disclosure, the width of the first bendable portion 553 and the width of the second bendable portion 555 may be the same. For example, in the embodiment of FIG. 8B, a first folding width (e.g., the first folding width BW1 of FIG. 8B) corresponding to the first bendable portion 553 in a direction (e.g., the x-axis direction of FIG. 8B) perpendicular to the first folding axis (e.g., F1 of FIG. 8B) may be substantially the same as the second folding width (e.g., the second folding width BW2 of FIG. 8B) corresponding to the second bendable portion 555.

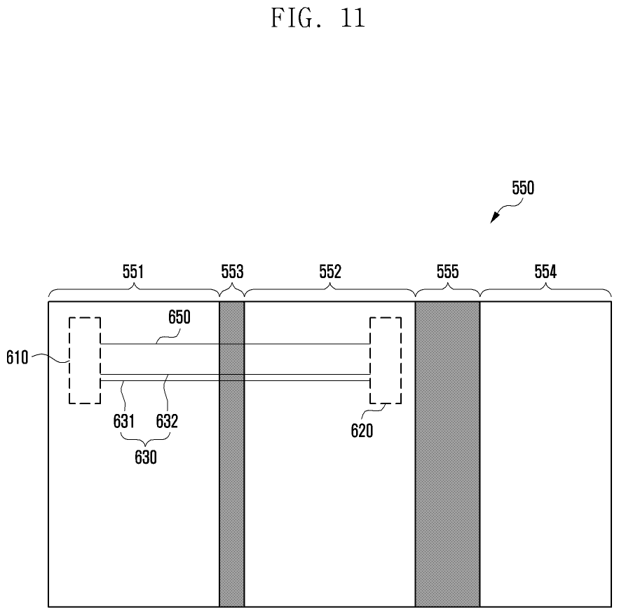

Referring to FIG. 11, the support plate 550 (e.g., the support plate 550 of FIG. 6) may have different widths for the first bendable portion 553 and the second bendable portion 555, unlike the embodiment of FIG. 10. Hereinafter, for the embodiment of FIG. 11, only the differences from the embodiment of FIG. 10 will be described. Accordingly, features not described with reference to FIG. 11 will be replaced with the description of the embodiment of FIG. 10.

According to the embodiment illustrated in FIG. 11, in the support plate 550, the width of the first bendable portion 553 may be smaller than the width of the second bendable portion 555. Accordingly, in the embodiment of FIG. 8B, a first folding width (e.g., the first folding width BW1 of FIG. 8B) corresponding to the first bendable portion 553 in a direction (e.g., the x-axis direction of FIG. 8B) perpendicular to the first folding axis (e.g., F1 of FIG. 8B) may be smaller than the second folding width (e.g., the second folding width BW2 of FIG. 8B) corresponding to the second bendable portion 555.

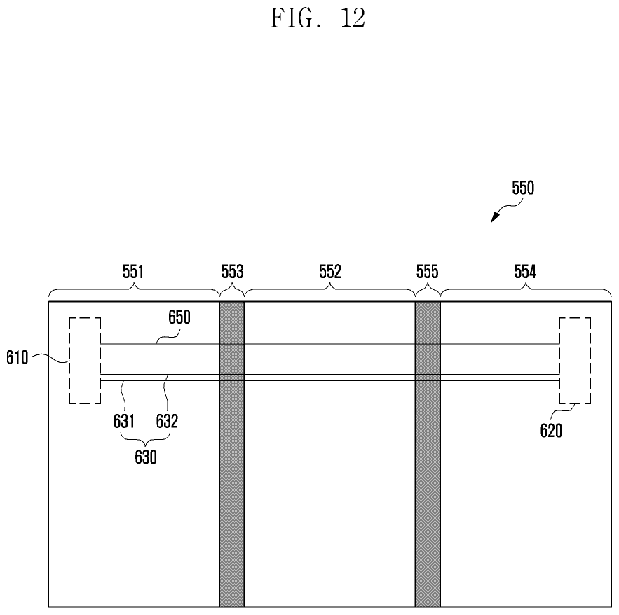

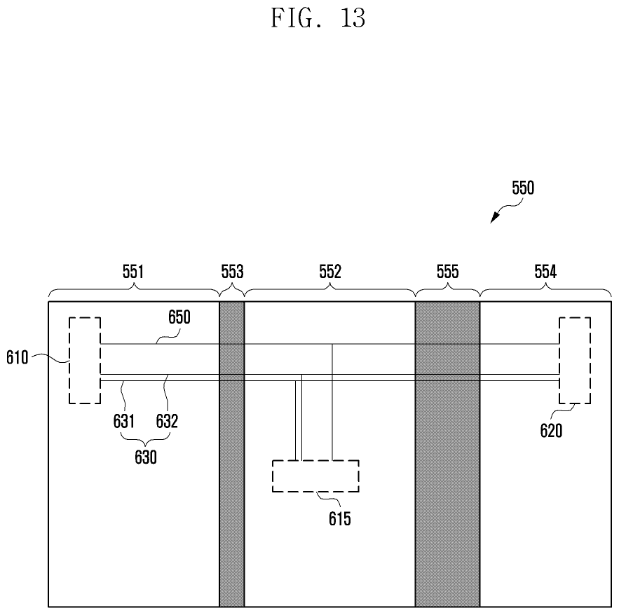

Referring to FIG. 12, the support plate 550 (e.g., the support plate 550 of FIG. 6) differs from the embodiment illustrated in FIG. 10 in that the differential signal line 630, the ground line (e.g., the ground line 640 of FIG. 16), and the RF signal line 650 extend from the first flat portion 551 to the second flat portion 552 across the first bendable portion 553, and further extend from the second flat portion 552 to the third flat portion 554 across the second bendable portion 555. Hereinafter, for the embodiment of FIG. 13, only the differences from the embodiment of FIG. 10 will be described. Accordingly, features not described with reference to FIG. 13 will be replaced with the description of the embodiment of FIG. 10.

The differential signal line 630, the ground line, and the RF signal line 650 of the support plate 550 may serve to electrically connect a first component 610 (e.g., a first substrate) disposed in the third housing (e.g., the third housing 730 of FIG. 8A) and a second component 620 (e.g., a second substrate) disposed in the second housing (e.g., the second housing 720 of FIG. 8A). Accordingly, the multi-foldable electronic device (e.g., the multi-foldable electronic device 700 of FIG. 8A) may reduce or omit a PCB or an FPCB used for signal transmission.

Referring to FIG. 13, the support plate 550 (e.g., the support plate 550 of FIG. 6) may have different widths for the first bendable portion 553 and the second bendable portion 555, unlike the embodiment of FIG. 12. Hereinafter, for the embodiment of FIG. 13, only the differences from the embodiment of FIG. 12 will be described. Accordingly, features not described with reference to FIG. 13 will be replaced with the description of the embodiment of FIG. 12.

In the support plate 550 according to the embodiment illustrated in FIG. 13, the width of the first bendable portion 553 may be smaller than the width of the second bendable portion 555. Accordingly, in the embodiment of FIG. 8B, a first folding width (e.g., the first folding width BW1 of FIG. 8B) corresponding to the first bendable portion 553 in a direction (e.g., the x-axis direction of FIG. 8B) perpendicular to the first folding axis (e.g., F1 of FIG. 8B) may be smaller than the second folding width (e.g., the second folding width BW2 of FIG. 8B) corresponding to the second bendable portion 555.

Referring to FIG. 13, the differential signal line 630, the ground line (e.g., the ground line 640 of FIG. 16), and the RF signal line 650 may serve to electrically connect a first component 610 (e.g., a first substrate) disposed in the third housing (e.g., the third housing 730 of FIG. 8A) and a third component 615 (e.g., a third substrate) disposed in the first housing (e.g., the first housing 710 of FIG. 8A). For example, at least some of the differential signal line 630, the ground line, and the RF signal line 650 may branch in the second flat portion 552 and may be electrically connected to the third component 615.

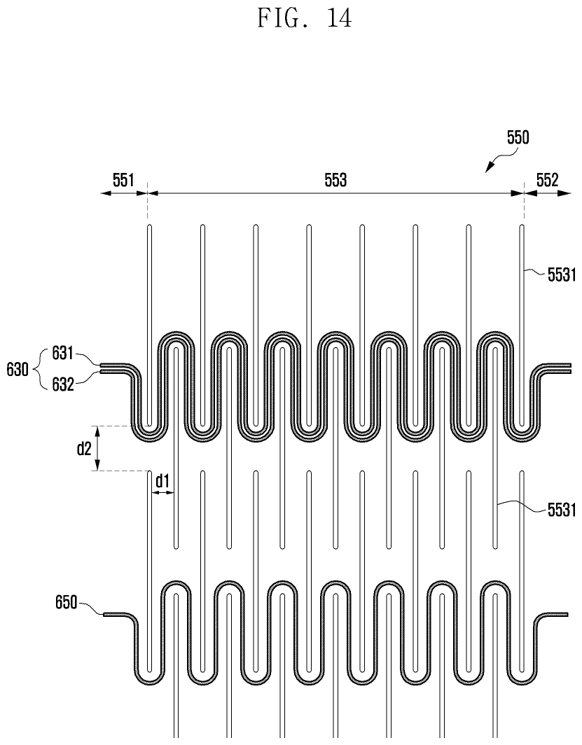

FIG. 14 is a plan view illustrating some of signal lines of a support plate 550 according to an embodiment of the disclosure.

The support plate 550 of FIG. 14 may be at least partially similar to the support plate 550 of FIGS. 5, 6, and 7.

Referring to FIG. 14, the support plate 550 according to the comparative example may include a differential signal line 630 including a first signal line 631 and a second signal line 632, and an RF signal line 650. The support plate 550 may further include a ground line (not illustrated) configured to serve as a reference plane. The ground line may extend to at least partially overlap the differential signal line 630.

According to the comparative example, the first signal line 631 and the second signal line 632 may be spaced apart from each other at a regular predetermined interval in the first flat portion 551, the bendable portion 553, and the second flat portion 552.

According to the comparative example, the bending characteristic of the support plate 550 may be determined by a first interval d1 between adjacent openings 5531 defined in a first direction of the bendable portion 553 and/or a second interval d2 between adjacent openings 5531 defined in a second direction perpendicular to the first direction. According to the comparative example, the first interval d1 and the second interval d2 of the openings 5531 in the bendable portion 553 may be limited to values equal to or smaller than a predetermined threshold in consideration of the bending characteristic of the bendable portion 553. Accordingly, due to the small width between the plurality of openings 5531, when the differential signal line 630 and the RF signal line 650 extend across the bendable portion 553, the design of the line width may be limited. When the design of the line width is limited, performance degradation of the differential signal line 630 and the RF signal line 650 may occur.

FIG. 15 is a plan view illustrating a portion of a differential signal line 630 of a support plate 550 according to an embodiment of the disclosure.

The support plate 550 of FIG. 15 may be at least partially similar to the support plates 550 of FIGS. 5, 6, 7, and 10 to 13, or may further include other embodiments for the support plate 550. The features of the support plate 550 described with reference to FIG. 15 may be applicable to the support plates 550 of FIGS. 5, 6, 7, and 10 to 13.

Referring to FIG. 15, the support plate 550 according to an embodiment (e.g., the support plate 550 of FIG. 6) may include a differential signal line 630. The differential signal line 630 may be disposed to extend from at least a portion of the first flat portion 551 to at least a portion of the second flat portion 552 across a bendable portion 553 (e.g., the first bendable portion 553 or the second bendable portion 555 of FIG. 10), and may include a first signal line 631 and a second signal line 632.

In the first flat portion 551 and the second flat portion 552, the first signal line 631 and the second signal line 632 may be arranged in parallel at a predetermined interval.

In the bendable portion 553, the first signal line 631 may extend along a first curved path 810 that bypasses the plurality of openings 5531, and the second signal line 632 may extend across the bendable portion 553 along a path different from that of the first signal line 631. For example, in the bendable portion 553, the second signal line 632 may extend along a second curved path 820 that bypasses the plurality of openings 5531. Here, the second curved path 820 may differ from the first curved path 810.

The first curved path 810 may include a plurality of U-shaped portions disposed around the plurality of openings 5531. The second curved path 820 may include a plurality of U-shaped portions disposed around the plurality of openings 5531.

The first curved path 810 and the second curved path 820 may be disposed adjacent to different portions of the plurality of openings 5531. For example, the first curved path 810 may be disposed adjacent to a first portion of the plurality of openings 5531, and the second curved path 820 may be disposed adjacent to a second portion of the plurality of openings 5531.

The plurality of U-shaped portions included in the first curved path 810 and the plurality of U-shaped portions included in the second curved path 820 may be arranged symmetrically. For example, the plurality of U-shaped portions included in the first curved path 810 and the plurality of U-shaped portions included in the second curved path 820 may form mirror images of each other.

The plurality of U-shaped portions included in the first curved path 810 and the plurality of U-shaped portions included in the second curved path 820 may bypass different portions of the plurality of openings 5531.

The widths of the first signal line 631 and the second signal line 632 may remain constant in the first flat portion 551 and the second flat portion 552, and may vary in the bendable portion 553. For example, in the first flat portion 551 and the second flat portion 552, each of the first signal line 631 and the second signal line 632 may have a first width W1. For example, in the bendable portion 553, each of the first signal line 631 and the second signal line 632 may have a first width W1 or a second width W2 that is equal to or greater than the first width W1. For example, in the bendable portion 553, the second width W2 of each of the first signal line 631 and the second signal line 632 may be at least about 50% of the interval between adjacent openings 5531.

In the bendable portion 553, the width of each of the first signal line 631 and the second signal line 632 may vary depending on whether they are adjacent to each other. For example, in the bendable portion 553, the first signal line 631 and the second signal line 632 may have a relatively great second width W2 in some portions of the path where they are spaced apart from each other, and a relatively small first width W1 in other portions of the path where they are adjacent to each other.

The first curved path in which the first signal line 631 is disposed may include at least one first adjacent path 811 adjacent to the second signal line 632, and the first signal line 631 may have the first width W1 in the first adjacent path 811. In the disclosure, the first adjacent path 811 may refer to a path in the bendable portion 553 where the first signal line 631 approaches the second signal line 632 within a predetermined distance. The first signal line 631 may have the second width W2 in the first curved path 810 of the bendable portion 553, except in the first adjacent path 811.

The second curved path 820 in which the second signal line 632 is disposed may include at least one second adjacent path 821 adjacent to the first signal line 631, and the second signal line 632 may have the first width W1 in the second adjacent path 821. In the disclosure, the first adjacent path 811 may refer to a path in the bendable portion 553 where the first signal line 631 approaches the second signal line 632 within a predetermined distance. The second signal line 632 may have the second width W2 in the second curved path 820 of the bendable portion 553, except in the second adjacent path 821.

The support plate 550 may have a multi-layer structure including a plurality of layers, and the differential signal line 630 may be disposed in at least some of the layers. For example, the differential signal line 630 may be disposed in a first metal layer (e.g., the first metal layer L1 of FIG. 18A) among the plurality of layers.

FIG. 16 is a plan view illustrating a portion of a ground line 640 of a support plate 550 according to an embodiment of the disclosure.

The support plate 550 of FIG. 16 may be at least partially similar to the support plates 550 of FIGS. 5, 6, and 7, or may further include other embodiments for the support plate 550. The features of the support plate 550 described with reference to FIG. 16 may be applicable to the support plates 550 of FIGS. 5, 6, 7, and 10 to 13.

Referring to FIG. 16, the support plate 550 (e.g., the support plate 550 of FIG. 6) may include a ground line 640 serving as a reference plane. For example, the ground line 640 may extend to at least partially overlap the differential signal line 630 described with reference to FIG. 15.

The support plate 550 may have a multi-layer structure including a plurality of layers, and the ground line 640 may be disposed in at least some of the layers. For example, the ground line 640 may be disposed in a second metal layer L2, a third metal layer L3, or both the second metal layer L2 and the third metal layer L3 among the plurality of layers. The second metal layer L2 or the third metal layer L3 may be different from the first metal layer L1 in which the differential signal line 630 described in the embodiment of FIG. 15 is disposed. For example, the second metal layer L2 may be a layer disposed above the first metal layer L1. For example, the third metal layer L3 may be a layer disposed below the first metal layer L1.

According to the embodiment illustrated in FIG. 16, like the differential signal line 630 described in the embodiment of FIG. 15, the ground line 640 may be disposed to extend from at least a portion of the first flat portion 551 to at least a portion of the second flat portion 552 across the bendable portion 553 (e.g., the first bendable portion 553 or the second bendable portion 555 of FIG. 10), and may at least partially overlap the differential signal line 630.

The ground line 640 may have a third width W3 in the first flat portion 551 and the second flat portion 552.

In the bendable portion 553, the ground line 640 may have the third width W3 or a fourth width W4 that is smaller than the third width W3.

The ground line 640 may have the third width W3 in a path overlapping a first adjacent path (e.g., the first adjacent path 811 of FIG. 15) and a second adjacent path (e.g., the second adjacent path 821 of FIG. 15), where the first signal line 631 and the second signal line 632 are disposed adjacent to each other.

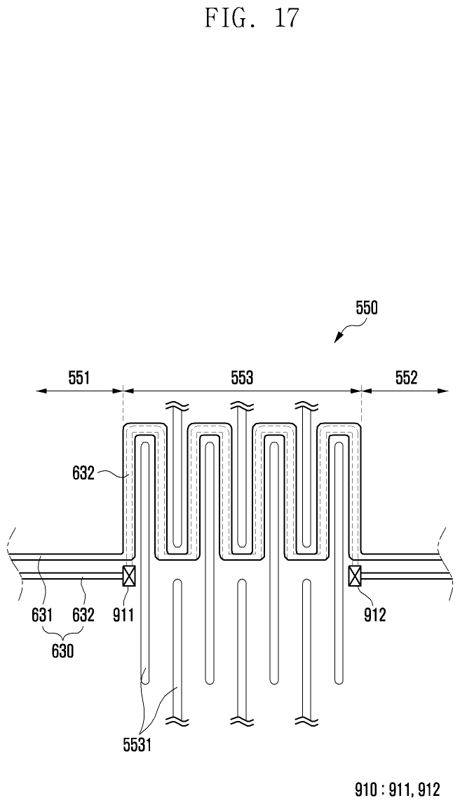

FIG. 17 is a plan view illustrating a portion of a differential signal line 630 of a support plate 550 according to an embodiment of the disclosure.

The support plate 550 of FIG. 17 may be at least partially similar to the support plates 550 of FIGS. 5, 6, and 7, or may further include other embodiments for the support plate 550. The features of the support plate 550 described with reference to FIG. 17 may be applicable to the support plates 550 of FIGS. 5, 6, 7, and 10 to 13.

Referring to FIG. 17, the support plate 550 (e.g., the support plate 550 of FIG. 6) differs from the embodiment of FIG. 15 in that the differential signal line 630 includes a multilayer structure. Hereinafter, for the embodiment of FIG. 17, only the differences from the embodiment of FIG. 15 will be described. Accordingly, features not described with reference to FIG. 17 will be replaced with the description of the embodiment of FIG. 15.

Referring to FIG. 17, the support plate 550 may include at least one differential signal line 630 including a first signal line 631 and a second signal line 632. The differential signal line 630 may be disposed to extend from at least a portion of the first flat portion 551 to at least a portion of the second flat portion 552 across the bendable portion 553.

The support plate 550 may be configured such that the first signal line 631 and the second signal line 632 may be arranged in a horizontal manner in the first flat portion 551 and the second flat portion 552, and in a vertical manner in the bendable portion 553.

In the first flat portion 551 and the second flat portion 552, the first signal line 631 and the second signal line 632 may be arranged in parallel at a predetermined interval.

In the bendable portion 553, the first signal line 631 may extend along a first curved path bypassing the plurality of openings 5531, and the second signal line 632 may extend along a second curved path that overlaps with the first curved path. For example, the second signal line 632 may extend along the second curved path that overlaps at least a portion of the first curved path, and may be disposed on a different layer from the first signal line 631 in the second curved path. In this manner, the first signal line 631 may have a single-layer structure disposed in one metal layer, whereas the second signal line 632 may have a multi-layer structure disposed in multiple metal layers.

In the first flat portion 551 and the second flat portion 552, the first signal line 631 and the second signal line 632 may be disposed in the same layer. In the bendable portion 553, the first signal line 631 and the second signal line 632 may be disposed in different layers. For example, the second signal line 632 may be designed in a multi-layer structure including an upper line section disposed in the same layer as the first signal line 631 in the first flat portion 551 and the second flat portion 552, and a lower line section electrically connected to the upper line section via vias 910 and overlapping at least a portion of the first signal line 631 in the bendable portion 553. In FIG. 17, the upper line section of the second signal line 632 is illustrated using solid lines, and the lower line section is illustrated using dashed lines.

The vias 910 that electrically connect the upper line section and the lower line section of the second signal line 632 may include a first via 911 disposed in at least a portion of a boundary between the first flat portion 551 and the bendable portion 553, and a second via 912 disposed in at least a portion of a boundary between the second flat portion 552 and the bendable portion 553.

The support plate 550 according to an embodiment may further include the ground line 640 described with reference to FIG. 16. For example, the ground line 640 may be disposed on a different layer from the differential signal line 630, and may be disposed to extend from at least a portion of the first flat portion 551 to at least a portion of the second flat portion 552 across the bendable portion 553, and may at least partially overlap the differential signal line 630.

According to the embodiment illustrated in FIG. 17, in a design condition where the width between the openings 5531 in the bendable portion 553 (e.g., d1 and d2 of FIG. 6) is limited, the line widths may be increased by configuring the first signal line 631 and the second signal line 632 to have a multilayer structure in which they extend in an overlapping manner. Accordingly, the embodiment illustrated in FIG. 17 may suppress performance degradation of the differential signal line 630 in the bendable portion 553.

FIGS. 18A, 18B, 19A, 19B, 20A, 20B, and 21A to 21C are cross-sectional views illustrating various embodiments for the laminated structure of the support plate 550 illustrated in FIG. 17 according to various embodiments of the disclosure. For example, FIGS. 18A, 18B, 19A, 19B, 20A, 20B, and 21A to 21C illustrate cross-sectional views of portions of the support plates 550 corresponding to the first flat portion 551 and the second flat portion 552 on the left side, and cross-sectional views of other portions of the support plates 550 corresponding to the bendable portion 553 on the right side.

The support plates 550 illustrated in FIGS. 18A, 18B, 19A, 19B, 20A, 20B, and 21A to 21C may be at least partially similar to the support plates 550 of FIGS. 5, 6, and 7, or may further include other embodiments for the support plate 550. The features of the support plates 550 described with reference to FIGS. 18A, 18B, 19A, 19B, 20A, 20B, and 21A to 21C may be applied to the support plates 550 of FIGS. 5, 6, 7, and 10 to 13.

Referring to FIG. 18A, the support plate 550 (e.g., the support plate 550 of FIG. 6) may have a multi-layer structure including a plurality of layers, and the differential signal line 630 may be disposed in at least some of the plurality of layers.

The support plate 550 may include a first metal layer L1, a second metal layer L2 disposed above the first metal layer L1, a third metal layer L3 disposed below the first metal layer L1, and/or a fourth metal layer L4 disposed below the third metal layer L3. For example, the support plate 550 may include the second metal layer L2, and may further include the first metal layer L1, the third metal layer L3, and the fourth metal layer L4 which are sequentially disposed below the second metal layer L2. According to various embodiments of the disclosure, the support plate 550 may further include metal layers other than those illustrated in FIGS. 18A, 18B, 19A, 19B, 20A, 20B, 21A, 21B, and 21C, and the disclosure is not limited thereto.

In the first flat portion 551 and the second flat portion 552, the differential signal line 630 may be disposed in the first metal layer L1. For example, in the first flat portion 551 and the second flat portion 552, the first signal line 631 and the second signal line 632 may be arranged at a predetermined interval.

In the first flat portion 551 and the second flat portion 552, the differential signal line 630 may be configured in a stripline form in which ground lines 640 are disposed respectively above and below the differential signal line. For example, in the first flat portion 551 and the second flat portion 552, the ground lines 640 may be disposed in the second metal layer L2 and the third metal layer L3, and may be arranged to at least partially overlap the first signal line 631 and the second signal line 632.

In the bendable portion 553, the differential signal line 630 may be disposed in a multilayer structure. For example, in the bendable portion 553, the first signal line 631 may be disposed in the first metal layer L1, and the second signal line 632 may be disposed in the third metal layer L3. Here, the second signal line 632 may be disposed in the third metal layer L3 to at least partially overlap the first signal line 631. The end portion of the second signal line 632 disposed in the third metal layer L3 corresponding to the bendable portion 553 may be electrically connected to the second signal lines 632 disposed in the first metal layer L1 corresponding to the first flat portion 551 and the second flat portion 552 through vias (e.g., the vias 910 in FIG. 17).

In the bendable portion 553, the differential signal line 630 may be implemented in a stripline form in which ground lines 640 are disposed respectively above and below the differential signal line. For example, in the bendable portion 553, the ground lines 640 may be disposed in the second metal layer L2 and the fourth metal layer L4, respectively, and may be arranged to at least partially overlap the first signal line 631 and the second signal line 632. The end portion of the ground line 640 disposed in the fourth metal layer L4 corresponding to the bendable portion 553 may be electrically connected to the ground line 640 disposed in the third metal layer L3 corresponding to the first flat portion 551 and the second flat portion 552 through vias (not illustrated).

According to the embodiment illustrated in FIG. 18A, the support plate 550 may allow the differential signal line 630 to be disposed even under design conditions in which the intervals between the openings 5531 are narrow, by disposing the first signal line 631 and the second signal line 632 in different layers in the bendable portion 553.

Referring to FIG. 18B, the support plate 550 (e.g., the support plate 550 of FIG. 6) according to an embodiment may differ from the embodiment of FIG. 18A in that the laminated structure of the ground line 640 is changed. Hereinafter, only the differences in the embodiment of FIG. 18B compared to the embodiment of FIG. 18A will be described. Accordingly, the features not described with reference to FIG. 18B will be replaced with the descriptions of the embodiment of FIG. 18A.

The laminated structure of the ground line 640 serving as a reference plane may be variously modified. For example, in the first flat portion 551 and the second flat portion 552, the ground lines 640 may be disposed in the second metal layer L2 and the fourth metal layer L4, respectively, and may be arranged to at least partially overlap the first signal line 631 and the second signal line 632.

The support plate 550 illustrated in FIG. 18B may include a design structure in which a ground is filled and cut in the third metal layer L3. The ground line 640 in the fourth metal layer L4 corresponding to the first flat portion 551 and the second flat portion 552 may extend to be continuously connected to the ground line 640 in the fourth metal layer L4 corresponding to the bendable portion 553.

Compared to the embodiment illustrated in FIG. 18A, the embodiment illustrated in FIG. 18B may have increased impedance because the distance between the differential signal line 630 and the ground line 640 disposed below the differential signal line 630 (e.g., the ground line 640 of the fourth metal layer L4) is increased. Accordingly, in consideration of impedance matching, the support plate 550 may reduce the impedance by increasing the line width of the differential signal line 630 in the embodiment of FIG. 18B compared to the embodiment of FIG. 18A.

For reference, the impedance of the differential signal line 630 is inversely proportional to the line width of the differential signal line 630 and directly proportional to the interval between the first signal line 631 and the second signal line 632.

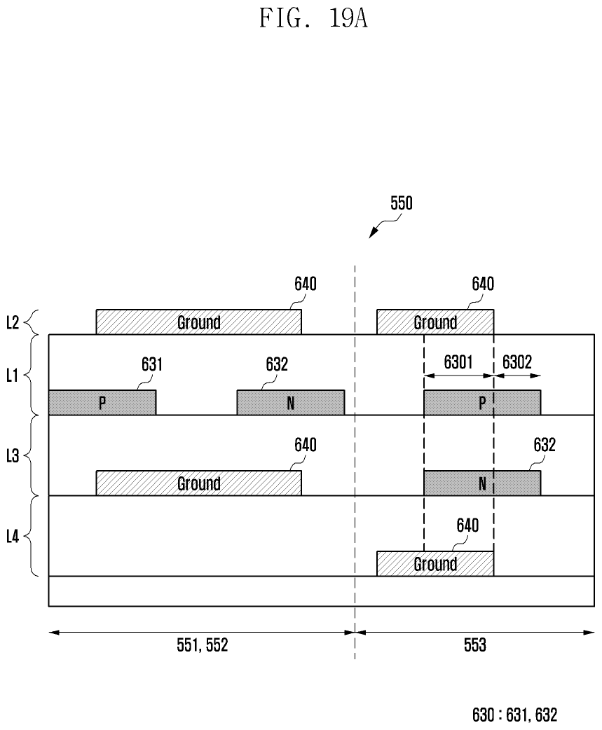

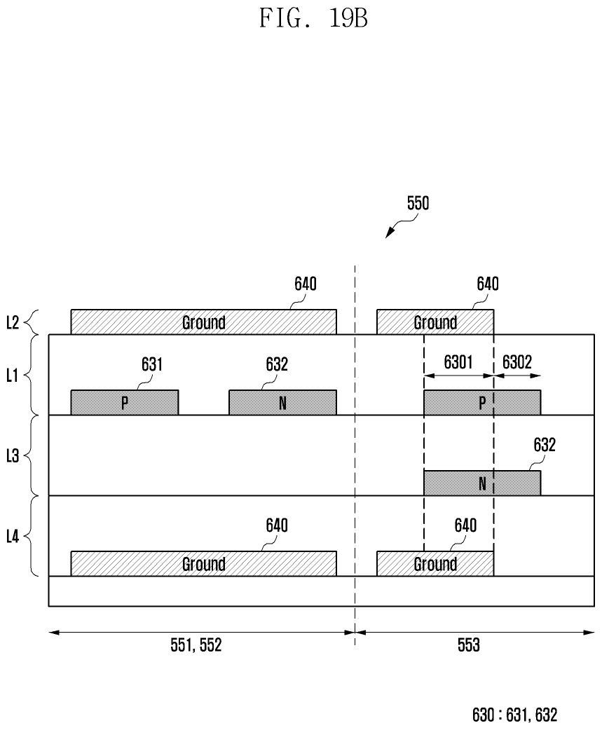

Referring to FIG. 19A, the support plate 550 (e.g., the support plate 550 of FIG. 6) may differ from the embodiment illustrated in FIG. 18A in that the line width of the differential signal line 630 is increased. Hereinafter, only the differences in the embodiment illustrated in FIG. 19A compared to the embodiment illustrated in FIG. 18A will be described. Accordingly, the features not described with reference to FIG. 19A will be replaced with the descriptions of the embodiment illustrated in FIG. 18A.

The support plate 550 may increase the line width of the differential signal line 630 in the first flat portion 551 and the second flat portion 552, thereby reducing DC resistance (DCR) and minimizing signal loss. When the line width of the differential signal line 630 is increased, the impedance may decrease, and in consideration of this, the support plate 550 may reduce the overlapping area between the differential signal line 630 and the ground line 640. Likewise, the support plate 550 may be designed such that the differential signal line 630 and the ground line 640 do not completely overlap in the bendable portion 553, thereby allowing impedance matching, reducing DCR due to increased line width, and minimizing signal loss. For example, in the bendable portion 553, the differential signal line 630 may be divided into a first area 6301 that overlaps the ground line 640 and a second area 6302 that does not overlap the ground line 640.

Referring to FIG. 19B, the support plate 550 (e.g., the support plate 550 of FIG. 6) may differ from the embodiment illustrated in FIG. 19A in that the laminated structure of the ground line 640 is changed. Hereinafter, only the differences in the embodiment illustrated in FIG. 19B compared to the embodiment of FIG. 19A will be described. Accordingly, the features not described with reference to FIG. 19B will be replaced with the descriptions of the embodiment illustrated in FIG. 19A.

The laminated structure of the ground line 640 serving as a reference plane may be variously modified. For example, in the first flat portion 551 and the second flat portion 552, the ground lines 640 may be disposed in the second metal layer L2 and the fourth metal layer L4, respectively, and may be arranged to at least partially overlap the first signal line 631 and the second signal line 632.

The support plate 550 illustrated in FIG. 19B may include a design structure in which a ground is filled and cut in the third metal layer L3. The ground line 640 in the fourth metal layer L4 corresponding to the first flat portion 551 and the second flat portion 552 may extend to be continuously connected to the ground line 640 in the fourth metal layer L4 corresponding to the bendable portion 553.

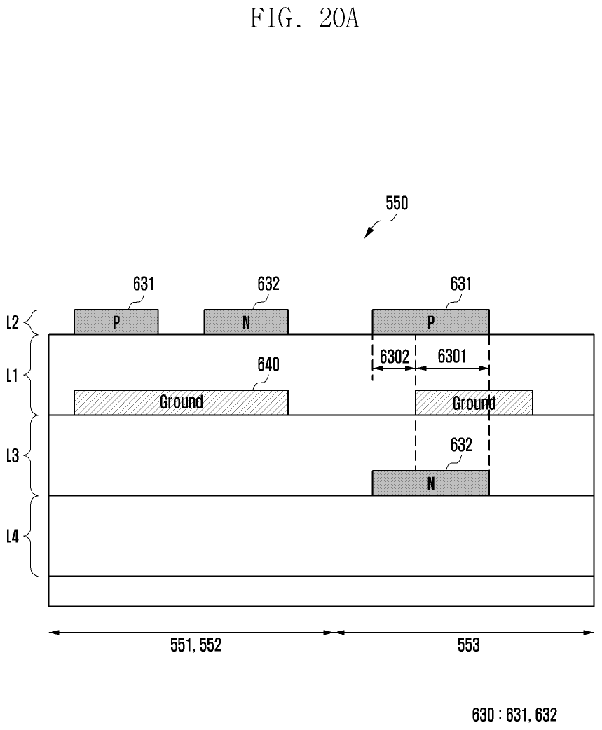

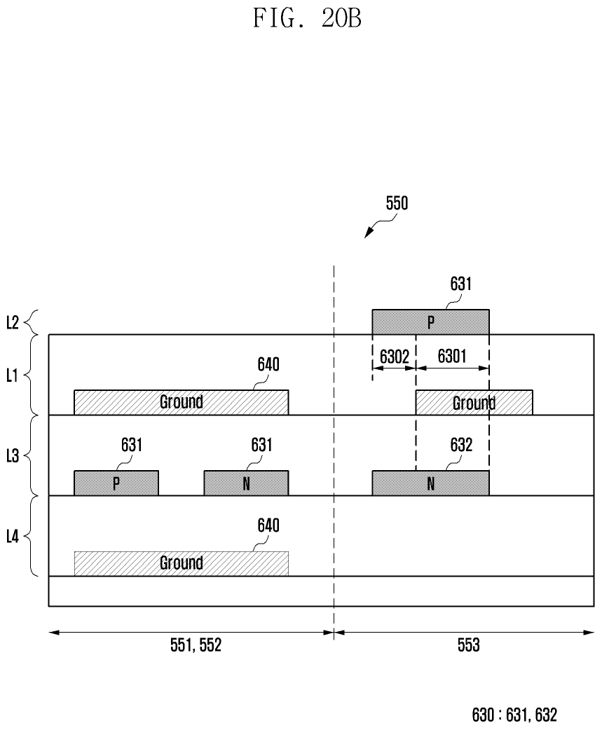

Referring to FIG. 20A, the support plate 550 (e.g., the support plate 550 of FIG. 6) may differ from the embodiment illustrated in FIG. 18A n that the differential signal line 630 is implemented in a microstrip form in which it overlaps a single ground line 640. Hereinafter, only the differences in the embodiment of FIG. 20A compared to the embodiment illustrated in FIG. 18A will be described. Accordingly, the features not described with reference to FIG. 20A will be replaced with the descriptions of the embodiment illustrated in FIG. 18A.

In the first flat portion 551 and the second flat portion 552, the differential signal line 630 may be disposed in the second metal layer L2. For example, in the first flat portion 551 and the second flat portion 552, the first signal line 631 and the second signal line 632 may be arranged at an interval.

In the first flat portion 551 and the second flat portion 552, the differential signal line 630 may be implemented in a microstrip form in which the ground line 640 is disposed below the differential signal line. For example, in the first flat portion 551 and the second flat portion 552, the ground line 640 may be disposed in the first metal layer L1 and arranged to at least partially overlap the first signal line 631 and the second signal line 632.

In the bendable portion 553, the differential signal line 630 may be disposed in a multilayer structure. For example, in the bendable portion 553, the first signal line 631 may be disposed in the second metal layer L2, and the second signal line 632 may be disposed in the third metal layer L3. Here, the second signal line 632 may be disposed in the third metal layer L3 to at least partially overlap the first signal line 631. The end portion of the second signal line 632 disposed in the third metal layer L3 corresponding to the bendable portion 553 may be electrically connected to the second signal lines 632 disposed in the second metal layer L2 corresponding to the first flat portion 551 and the second flat portion 552 through vias (e.g., the vias 910 in FIG. 17).

In the bendable portion 553, the ground line 640 may be disposed in the first metal layer L1 and may be arranged to at least partially overlap the first signal line 631 and the second signal line 632.

In the bendable portion 553, the differential signal line 630 may be divided into a first area 6301 that overlaps the ground line 640 and a second area 6302 that does not overlap the ground line 640, in consideration of impedance matching.

Referring to FIG. 20B, the support plate 550 (e.g., the support plate 550 of FIG. 6) may differ from the embodiment illustrated in FIG. 20A in that the laminated structure of each of the differential signal line 630 and the ground line 640 is changed. Hereinafter, only the differences in the embodiment of FIG. 20B compared to the embodiment illustrated in FIG. 20A will be described. Accordingly, the features not described with reference to FIG. 20B will be replaced with the descriptions of the embodiment illustrated in FIG. 20A.

In the first flat portion 551 and the second flat portion 552, the differential signal line 630 may be disposed in the third metal layer L3. For example, in the first flat portion 551 and the second flat portion 552, the first signal line 631 and the second signal line 632 may be arranged at an interval.

In the first flat portion 551 and the second flat portion 552, the differential signal line 630 may be implemented in a stripline form in which ground lines 640 are disposed respectively above and below the differential signal line. For example, in the first flat portion 551 and the second flat portion 552, the ground lines 640 may be disposed in the first metal layer L1 and the fourth metal layer L4, respectively, and may be arranged to at least partially overlap the first signal line 631 and the second signal line 632.

In the bendable portion 553, the differential signal line 630 may be disposed in a multilayer structure. For example, in the bendable portion 553, the first signal line 631 may be disposed in the second metal layer L2, and the second signal line 632 may be disposed in the third metal layer L3. Here, the second signal line 632 may be disposed in the third metal layer L3 to at least partially overlap the first signal line 631. The end portion of the first signal line 631 disposed in the second metal layer L2 corresponding to the bendable portion 553 may be electrically connected to the first signal line 631 disposed in the third metal layer L3 corresponding to the first flat portion 551 and the second flat portion 552 through vias (not illustrated).

In the bendable portion 553, the ground line 640 may be disposed in the first metal layer L1 and may be arranged to at least partially overlap the first signal line 631 and the second signal line 632.

In consideration of impedance matching, in the bendable portion 553, the differential signal line 630 may be divided into a first area 6301 that overlaps the ground line 640 and a second area 6302 that does not overlap the ground line 640.

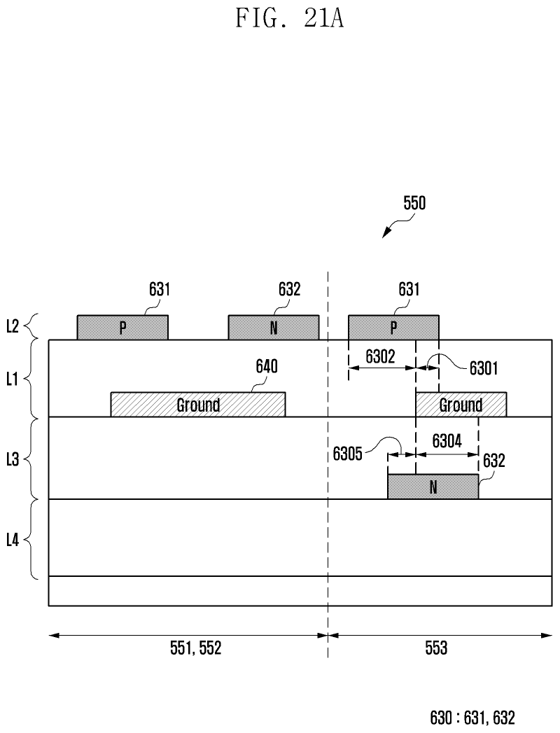

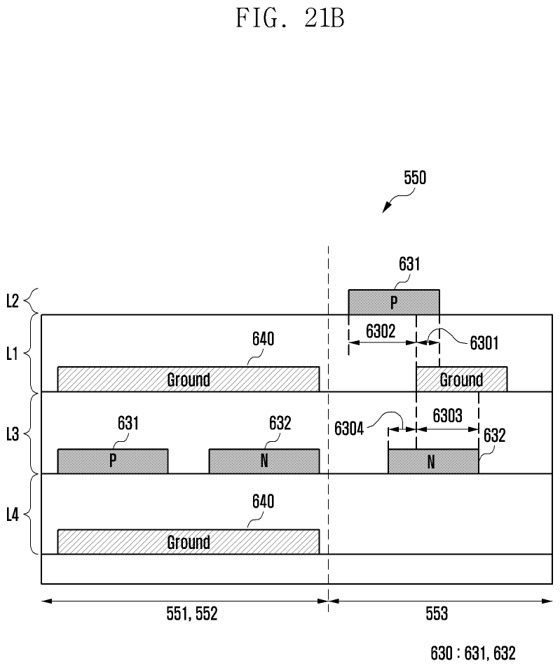

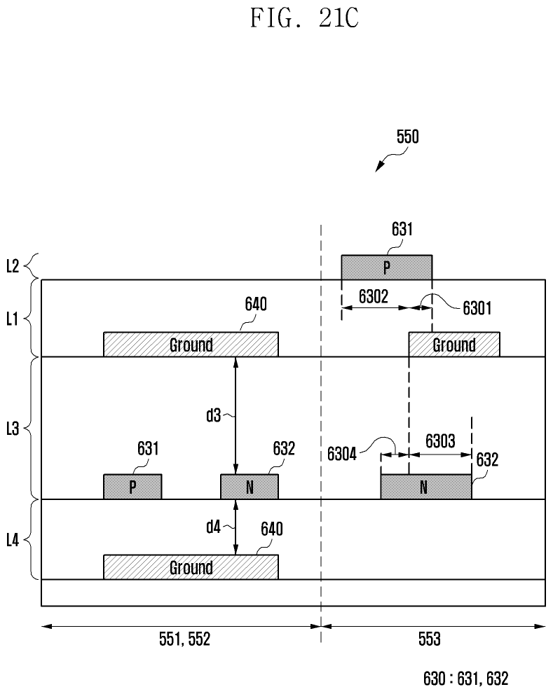

Referring to FIG. 21A, the support plate 550 (e.g., the support plate 550 of FIG. 6) may differ from the embodiment illustrated in FIG. 20A in that the line width of the differential signal line 630 is increased. Hereinafter, only the differences in the embodiment illustrated in FIG. 21A compared to the embodiment illustrated in FIG. 20A will be described. Accordingly, the features not described with reference to FIG. 21A will be replaced with the descriptions of the embodiment illustrated in FIG. 20A.

The support plate 550 may increase the line width of the differential signal line 630 in the first flat portion 551 and the second flat portion 552, thereby reducing DCR and minimizing signal loss. When the line width of the differential signal line 630 is increased, the impedance may decrease, and in consideration of this, the support plate 550 may reduce the overlapping area between the differential signal line 630 and the ground line 640. Likewise, the support plate 550 may be designed such that the differential signal line 630 and the ground line 640 do not completely overlap in the bendable portion 553, thereby allowing impedance matching, reducing DCR due to increased line width, and minimizing signal loss. For example, in the bendable portion 553, the differential signal line 630 may be divided into a first area 6301 that overlaps the ground line 640 and a second area 6302 that does not overlap the ground line 640.

In the bendable portion 553, the first signal line 631 may be divided into a first area 6301 that overlaps the ground line 640 and a second area 6302 that does not overlap the ground line 640, in consideration of impedance matching.

In the bendable portion 553, the second signal line 632 may not completely overlap the first signal line 631. In consideration of impedance matching, the second signal line 632 may be divided into a third area 6304 that overlaps the ground line 640 and a fourth area 6305 that does not overlap the ground line 640. For example, the width of the fourth area 6305 of the second signal line 632 may be different from the width of the second area 6302 of the first signal line 631.

Referring to FIG. 21B, the support plate 550 (e.g., the support plate 550 of FIG. 6) according to an embodiment may differ from the embodiment illustrated in FIG. 21A in that the laminated structure of each of the differential signal line 630 and the ground line 640 is changed. Hereinafter, only the differences in the embodiment illustrated in FIG. 21B compared to the embodiment illustrated in FIG. 21A will be described. Accordingly, the features not described with reference to FIG. 21B will be replaced with the descriptions of the embodiment illustrated in FIG. 21A.

In the first flat portion 551 and the second flat portion 552, the differential signal line 630 may be disposed in the third metal layer L3. For example, in the first flat portion 551 and the second flat portion 552, the first signal line 631 and the second signal line 632 may be arranged at an interval.

In the first flat portion 551 and the second flat portion 552, the differential signal line 630 may be implemented in a stripline form in which ground lines 640 are disposed respectively above and below the differential signal line. For example, in the first flat portion 551 and the second flat portion 552, the ground lines 640 may be disposed in the first metal layer L1 and the fourth metal layer L4, respectively, and may be arranged to at least partially overlap the first signal line 631 and the second signal line 632.

In the bendable portion 553, the differential signal line 630 may be disposed in a multilayer structure. For example, in the bendable portion 553, the first signal line 631 may be disposed in the second metal layer L2, and the second signal line 632 may be disposed in the third metal layer L3. Here, the second signal line 632 may be disposed in the third metal layer L3 to at least partially overlap the first signal line 631. The end portion of the first signal line 631 disposed in the second metal layer L2 corresponding to the bendable portion 553 may be electrically connected to the first signal line 631 disposed in the third metal layer L3 corresponding to the first flat portion 551 and the second flat portion 552 through vias (not illustrated).

In the bendable portion 553, the ground line 640 may be disposed in the first metal layer L1 and may be arranged to at least partially overlap the first signal line 631 and the second signal line 632.

In consideration of impedance matching, in the bendable portion 553, the differential signal line 630 may be divided into a first area 6301 that overlaps the ground line 640 and a second area 6302 that does not overlap the ground line 640.

The bendable portion 553, the ground line 640 may be arranged in a single-layer structure. For example, in the bendable portion 553, the ground line 640 may be disposed in the first metal layer L1.

Referring to FIG. 21C, the support plate 550 (e.g., the support plate 550 of FIG. 6) according to an embodiment may differ from the embodiment illustrated in FIG. 21B in that the line width of the differential signal line 630 is decreased. Hereinafter, only the differences in the embodiment illustrated in FIG. 21C compared to the embodiment illustrated in FIG. 21B will be described. Accordingly, the features not described with reference to FIG. 21C will be replaced with the descriptions of the embodiment illustrated in FIG. 21B.

The embodiment illustrated in FIG. 21C may differ from the embodiment illustrated in FIG. 21B in that the distance between the differential signal line 630 and the overlapping ground line 640 may be changed. For example, in the first flat portion 551 and the second flat portion 552, the distance d3 from the differential signal line 630 to the ground line 640 located in the first metal layer L1 above the differential signal line may increase. For example, in the first flat portion 551 and the second flat portion 552, the distance d4 (which is smaller than d3) from the differential signal line 630 to the ground line 640 located in the lower fourth metal layer L4 may decrease. In this case, the impedance of the differential signal line 630 may decrease compared to the embodiment of FIG. 21B. In consideration of the decreased impedance of the differential signal line 630 compared to the embodiment of FIG. 21B, the embodiment of FIG. 21C may increase the impedance by relatively reducing the line width of the differential signal line 630 and relatively increasing the interval between the first signal line 631 and the second signal line 632.

FIG. 22 is a plan view illustrating a portion of an RF signal line 650 of a support plate 550 according to an embodiment of the disclosure.

The support plate 550 of FIG. 22 may be at least partially similar to the support plates 550 of FIGS. 5, 6, and 7, or may further include other embodiments for the support plate 550. The features of the support plate 550 described with reference to FIG. 22 may be applicable to the support plates 550 of FIGS. 5, 6, 7, and 10 to 13.

Referring to FIG. 22, the support plate 550 (e.g., the support plate 550 of FIG. 6) may further include an RF signal line 650 that is disposed to extend from at least a portion of the first flat portion 551 to at least a portion of the second flat portion 552 across the bendable portion 553. The RF signal line 650 may be arranged at an interval from the differential signal line 630 according to various embodiments described in the disclosure.

In the bendable portion 553, the RF signal line 650 may include at least one first line section 1021 that branches into a third curved path 1011 and a fourth curved path 1012 bypassing the plurality of openings 5531, and at least one second line section 1022 in which the third curved path 1011 and the fourth curved path 1012 are merged into a single path. In the bendable portion 553, the structure in which the RF signal line 650 extends to branch in the first line section 1021 and then to merge again in the second line section 1022 may be repeated.

The RF signal line 650 may include a first line section 6501 that is disposed in the first flat portion 551 and the second flat portion 552 and is designed with an impedance of about 50 ohms, a second line section 6502 that branches in the bendable portion 553 to form at least one first line section 1021 and is designed with an impedance of about 100 ohms to about 120 ohms, and a third line section 6503 that merges into a single line in the bendable portion 553 and is designed with an impedance of about 50 ohms.

The RF signal line 650 may be designed with an impedance of about 100 ohms to about 120 ohms in the bendable portion 553 in order to improve an insertion loss characteristic. Since the RF signal line 650 includes a parallel design section having an impedance of about 100 ohms to about 120 ohms in the bendable portion 553, the overall impedance of the bendable portion 553 may be about 50 ohms.

The width of the RF signal line 650 in the first line section 1021 may be designed to be smaller than that in the second line section 1022. Accordingly, the RF signal line 650 may be designed with an impedance of about 100 ohms to about 120 ohms in the first line section 1021 of the bendable portion 553.

According to an embodiment of the disclosure, an electronic device may include a foldable housing including a first housing, a second housing, and a hinge structure connecting the first housing and the second housing, and a flexible display disposed on the foldable housing. The flexible display may include a display panel, a polymer member disposed on a rear surface of the display panel, and a support plate 550 disposed on a rear surface of the polymer member. The support plate 550 may include a first flat portion 551 facing the first housing, a second flat portion 552 facing the second housing, and a bendable portion 553 disposed between the first flat portion 551 and the second flat portion 552 to face the hinge structure. The bendable portion 553 is configured to be bendable via a plurality of openings 5531 arranged at intervals. The support plate 550 may further include at least one differential signal line 630 including a first signal line 631 and a second signal line 632, which extend from at least a portion of the first flat portion 551 to at least a portion of the second flat portion 552 across the bendable portion 553. The first signal line 631 and the second signal line 632 may be disposed on the first flat portion 551 and the second flat portion 552. In the bendable portion 553, the first signal line 631 extends along a first curved path including a plurality of U-shaped sections disposed around the plurality of openings 5531. In the bendable portion 553, the second signal line 632 may extend along a second curved path including a plurality of U-shaped sections disposed around the plurality of openings 5531.

In the first flat portion 551 and the second flat portion 552, each of the first signal line 631 and the second signal line 632 may have a first width. In the bendable portion 553, each of the first signal line 631 and the second signal line 632 may have the first width or a second width greater than the first width.

The first curved path on which the first signal line 631 is disposed may include at least one first adjacent path adjacent to the second signal line 632, and the first signal line 631 may have the first width in the first adjacent path. The second curved path on which the second signal line 632 is disposed may include at least one second adjacent path adjacent to the first signal line 631, and the second signal line 632 may have the first width in the second adjacent path.

The support plate 550 may further include a ground line 640 disposed on a different layer from the differential signal line 630. The ground line 640 may be disposed to extend from at least a portion of the first flat portion 551 to at least a portion of the second flat portion 552 across the bendable portion 553 and may at least partially overlap the differential signal line 630.

In the first flat portion 551 and the second flat portion 552, the ground line 640 may have a third width. In the bendable portion 553, the ground line 640 may have the third width or a fourth width smaller than the third width.

The ground line 640 may have the third width in a path overlapping the first adjacent path and the second adjacent path in which the first signal line 631 and the second signal line 632 are disposed adjacent to each other.

The support plate 550 may further include an RF signal line 650 disposed to extend from at least a portion of the first flat portion 551 to at least a portion of the second flat portion 552 across the bendable portion 553. In the bendable portion 553, the RF signal line 650 may include at least one first line section branched into a third curved path and a fourth curved path bypassing the plurality of openings 5531, and at least one second line section in which the third curved path and the fourth curved path merge into a single path.

In the first flat portion 551 and the second flat portion 552, the RF signal line 650 may be designed to have an impedance of about 50 ohms. In the bendable portion 553, the first line section of the RF signal line 650 may be designed to have an impedance of about 100 ohms, and the second line section of the RF signal line 650 in the bendable portion 553 may be designed to have an impedance of about 50 ohms.

The support plate 550 may include glass fiber reinforced plastic (GFRP).

The support plate 550 may include carbon fiber reinforced plastic (CFRP).

The first curved path and the second curved path may be disposed adjacent to different portions of the plurality of openings.

The plurality of U-shaped sections included in the first curved path and the plurality of U-shaped sections included in the second curved path may be disposed symmetrically with respect to each other.

The plurality of U-shaped sections included in the first curved path and the plurality of U-shaped sections included in the second curved path may bypass different portions of the plurality of openings.

According to an embodiment of the disclosure, an electronic device may include a foldable housing including a first housing, a second housing, and a hinge structure connecting the first housing and the second housing, and a flexible display disposed on the foldable housing. The flexible display may include a display panel, a polymer member disposed on a rear surface of the display panel, and a support plate 550 disposed on a rear surface of the polymer member. The support plate 550 may include a first flat portion 551 facing the first housing, a second flat portion 552 facing the second housing, and a bendable portion 553 disposed between the first flat portion 551 and the second flat portion 552 to face the hinge structure and configured to be bendable via a plurality of openings 5531 arranged at intervals. The support plate 550 may further include at least one differential signal line 630 including a first signal line 631 and a second signal line 632. The differential signal line 630 may be disposed to extend from at least a portion of the first flat portion 551 to at least a portion of the second flat portion 552 across the bendable portion 553. In the first flat portion 551 and the second flat portion 552, the first signal line 631 and the second signal line 632 may be disposed side by side at a predetermined interval. In the bendable portion 553, the first signal line 631 may extend along a first curved path bypassing the plurality of openings 5531. In the bendable portion 553, the second signal line 632 may extend along a second curved path that overlaps at least a portion of the first curved path, and the second signal line 632 may be disposed on a different layer from the first signal line 631 in the second curved path.

In the first flat portion 551 and the second flat portion 552, the first signal line 631 and the second signal line 632 may be disposed on the same layer, and in the bendable portion 553, the first signal line 631 and the second signal line 632 may be disposed on different layers.

The second signal line 632 may include an upper line section disposed on the same layer as the first signal line 631 in the first flat portion 551 and the second flat portion 552, and a lower line section electrically connected to the upper line section via a via and disposed to overlap at least a portion of the first signal line 631 in the bendable portion 553.

The via may be at least partially disposed at a boundary between the first flat portion 551 and the bendable portion 553, and at a boundary between the second flat portion 552 and the bendable portion 553.

In the first flat portion 551 and the second flat portion 552, each of the first signal line 631 and the second signal line 632 may have a first width. In the bendable portion 553, each of the first signal line 631 and the second signal line 632 may have the first width or a second width greater than the first width.

The support plate 550 may further include a ground line 640 disposed on a different layer from the differential signal line 630. The ground line 640 may be disposed to extend from at least a portion of the first flat portion 551 to at least a portion of the second flat portion 552 across the bendable portion 553 and may at least partially overlap the differential signal line 630.

The support plate 550 may further include an RF signal line 650 disposed to extend from at least a portion of the first flat portion 551 to at least a portion of the second flat portion 552 across the bendable portion 553. In the bendable portion 553, the RF signal line 650 may include at least one first line section branched into a third curved path and a fourth curved path bypassing the plurality of openings 5531, and at least one second line section in which the third curved path and the fourth curved path merge into a single path.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a foldable housing comprising a first housing, a second housing, and a hinge structure connecting the first housing and the second housing; and
a flexible display disposed on the foldable housing,
wherein the flexible display comprises:
a display panel,
a polymer member disposed on a rear surface of the display panel, and
a support plate disposed on a rear surface of the polymer member,
wherein the support plate comprises:
a first flat portion facing the first housing,
a second flat portion facing the second housing,
a bendable portion disposed between the first flat portion and the second flat portion to face the hinge structure and comprising a plurality of openings arranged at intervals, the bendable portion being configured to be bendable via the plurality of openings, and
at least one differential signal line comprising a first signal line and a second signal line, the at least one differential signal line extending from at least a portion of the first flat portion to at least a portion of the second flat portion across the bendable portion,
wherein the first signal line and the second signal line are disposed on the first flat portion and the second flat portion,
wherein, in the bendable portion, the first signal line extends along a first curved path comprising a plurality of U-shaped sections disposed around the plurality of openings, and
wherein, in the bendable portion, the second signal line extends along a second curved path comprising a plurality of U-shaped sections disposed around the plurality of openings.

2. The electronic device of claim 1,
wherein, in the first flat portion and the second flat portion, each of the first signal line and the second signal line has a first width, and
wherein, in the bendable portion, each of the first signal line and the second signal line has the first width or a second width greater than the first width.

3. The electronic device of claim 2,
wherein the first curved path on which the first signal line is disposed comprises at least one first adjacent path adjacent to the second signal line, the first signal line having the first width in the first adjacent path, and
wherein the second curved path on which the second signal line is disposed comprises at least one second adjacent path adjacent to the first signal line, the second signal line having the first width in the second adjacent path.

4. The electronic device of claim 3, wherein the support plate further comprises:
a ground line disposed on a different layer from the differential signal line, the ground line being disposed to extend from at least a portion of the first flat portion to at least a portion of the second flat portion across the bendable portion, and at least partially overlapping the differential signal line.

5. The electronic device of claim 4,
wherein, in the first flat portion and the second flat portion, the ground line has a third width, and
wherein, in the bendable portion, the ground line has the third width or a fourth width smaller than the third width.

6. The electronic device of claim 5, wherein the ground line has the third width in a path overlapping the first adjacent path and the second adjacent path in which the first signal line and the second signal line are disposed adjacent to each other.

7. The electronic device of claim 1,
wherein the support plate further comprises a radio frequency (RF) signal line disposed to extend from at least a portion of the first flat portion to at least a portion of the second flat portion across the bendable portion, and
wherein, in the bendable portion, the RF signal line comprises:
at least one first line section branched into a third curved path and a fourth curved path bypassing the plurality of openings, and
at least one second line section in which the third curved path and the fourth curved path merge into a single path.

8. The electronic device of claim 7,
wherein, in the first flat portion and the second flat portion, the RF signal line is designed to have an impedance of about 50 ohms,
wherein, in the bendable portion, the first line section of the RF signal line is designed to have an impedance of about 100 ohms, and
wherein, in the bendable portion, the second line section of the RF signal line is designed to have an impedance of about 50 ohms.

9. The electronic device of claim 1, wherein the support plate comprises glass fiber reinforced plastic (GFRP).

10. The electronic device of claim 1, wherein the support plate comprises carbon fiber reinforced plastic (CFRP).

11. The electronic device of claim 1, wherein the first curved path and the second curved path are disposed adjacent to different portions of the plurality of openings.

12. The electronic device of claim 1, wherein the plurality of U-shaped sections included in the first curved path and the plurality of U-shaped sections included in the second curved path are disposed symmetrically with respect to each other.

13. The electronic device of claim 1, wherein the plurality of U-shaped sections included in the first curved path and the plurality of U-shaped sections included in the second curved path bypass different portions of the plurality of openings.

14. An electronic device comprising:
a foldable housing comprising a first housing, a second housing, and a hinge structure connecting the first housing and the second housing; and
a flexible display disposed on the foldable housing,
wherein the flexible display comprises:
a display panel,
a polymer member disposed on a rear surface of the display panel, and
a support plate disposed on a rear surface of the polymer member,
wherein the support plate comprises:
a first flat portion facing the first housing,
a second flat portion facing the second housing,
a bendable portion disposed between the first flat portion and the second flat portion to face the hinge structure and comprising a plurality of openings arranged at intervals, the bendable portion being configured to be bendable via the plurality of openings, and
at least one differential signal line comprising a first signal line and a second signal line, the at least one differential signal line extending from at least a portion of the first flat portion to at least a portion of the second flat portion across the bendable portion,
wherein, in the first flat portion and the second flat portion, the first signal line and the second signal line are disposed side by side at a predetermined interval,
wherein, in the bendable portion, the first signal line extends along a first curved path bypassing the plurality of openings, and
wherein, in the bendable portion, the second signal line extends along a second curved path overlapping at least a portion of the first curved path, the second signal line being disposed on a different layer from the first signal line in the second curved path.

15. The electronic device of claim 14,
wherein, in the first flat portion and the second flat portion, the first signal line and the second signal line are disposed on a same layer, and
wherein, in the bendable portion, the first signal line and the second signal line are disposed on different layers.

16. The electronic device of claim 15, wherein the second signal line comprises:
an upper line section disposed on the same layer as the first signal line in the first flat portion and the second flat portion; and
a lower line section electrically connected to the upper line section via a via and disposed to overlap at least a portion of the first signal line in the bendable portion.

17. The electronic device of claim 16, wherein the via is at least partially disposed at a boundary between the first flat portion and the bendable portion, and at a boundary between the second flat portion and the bendable portion.

18. The electronic device of claim 14,
wherein, in the first flat portion and the second flat portion, each of the first signal line and the second signal line has a first width, and
wherein, in the bendable portion, each of the first signal line and the second signal line has the first width or a second width greater than the first width.

19. The electronic device of claim 18, wherein the support plate further comprises:
a ground line disposed on a different layer from the differential signal line, the ground line being disposed to extend from at least a portion of the first flat portion to at least a portion of the second flat portion across the bendable portion, and at least partially overlapping the differential signal line.

20. The electronic device of claim 14,
wherein the support plate further comprises a radio frequency (RF) signal line disposed to extend from at least a portion of the first flat portion to at least a portion of the second flat portion across the bendable portion, and
wherein, in the bendable portion, the RF signal line comprises at least one first line section branched into a third curved path and a fourth curved path bypassing the plurality of openings, and at least one second line section in which the third curved path and the fourth curved path merge into a single path.
